(19) United States
(12) Patent Application Publication
(10) Pub. No.: US 2010/0151104 A1
(43) Pub. Date: Jun. 17, 2010

(54) Preservative System For Beverages Based On Combinations Of Trans-Cinnamic Acid, Lauric Arginate, And Dimethyl Dicarbonate

(75) Inventor: Richard T. Smith, Ridgefield, CT (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/604,481

(22) Filed: Oct. 23, 2009

Related U.S. Application Data
(60) Provisional application No. 61/108,583, filed on Oct. 27, 2008.

(51) Int. Cl. A23L 3/34

(52) U.S. Cl. 426/532

(57) ABSTRACT

The present invention provides beverage preservative systems for use in beverages products, in particular high acid beverage products having a pH of 4.6 or less, and beverage products comprising the beverage preservative systems. The beverage preservative system prevents spoilage by microorganisms in a beverage within a sealed container for a period of at least 16 weeks. The present invention reduces or eliminates the use of conventional preservatives that pose health and/or environmental concerns. The components that make up the beverage preservative system of invention work together in an additive or synergistic manner to reduce the amount of preservative required and so improve the inventive beverage's sensory impact over beverages having conventional preservatives.

### TECHNICAL FIELD

This invention relates to beverage preservative systems and beverage products comprising the preservative system. In particular, this invention relates to beverage preservative systems having formulations suitable to meet consumer demand for healthy and environmentally friendly ingredients.

### BACKGROUND

Many food and beverage products include chemical preservatives to extend the shelf-life of the product by inhibiting the growth of spoilage microorganisms (e.g., mold, yeast, bacteria). However, some preservatives currently in use have been found to have detrimental health and/or environmental effects, or are not sufficiently stable. Therefore, there is market demand for food and beverage products which do not include these detrimental preservatives, and yet still possess extended shelf-life.

For example, benzoic acid and its salts are commonly used in beverage products as preservatives. However, in some beverage formulations that possess vitamin C and a relatively high pH, a small fraction of benzoic acid and its salts is prone to conversion into benzene (ppb quantities). Heat and certain wavelengths of light increase the rate of this reaction, so extra care need be taken in the production and storage of beverage such products when both benzoate and ascorbic acid are ingredients. Intake of benzene in drinking water is a public health concern, and the World Health Organization (WHO) and several governing bodies within the United States and the European Union have set upper limits for benzene content in drinking water of 10 ppb, 5 ppb, and 1 ppb, respectively.

Ethylenediamine tetraacetic acid (EDTA) and its salts are also common beverage product preservative. EDTA sequesters metal ions and can impact their participation in any number of chemical reactions. At elevated concentrations, EDTA can serve to starve bacteria of needed trace elements. At relatively low concentrations as typically found in beverage, EDTA facilitates the activity of at least weak acid preservatives such as sorbic and benzoic acid. However, EDTA is not bio-degradable, nor is it removed during conventional wastewater treatment. EDTA has surfaced as environmental concerns predominantly because of its persistence and strong metal chelating properties. Widespread use of EDTA and its slow removal under many environmental conditions have led to its status as the most abundant anthropogenic compound in many European surface waters. River concentrations of EDTA in Europe are reported in the range of 10-100 μg/L, and lake concentrations of EDTA are in the range of 1-10 μg/L. EDTA concentrations in U.S. groundwater receiving wastewater effluent discharge have been reported in the range of 1-72 μg/L, and EDTA was found to be an effected tracer for effluent, with higher concentrations of EDTA corresponding to a greater percentage of reclaimed water in drinking water production wells.

Polyphosphates are another type of sequestrant employed as a beverage product preservative. However, polyphosphates are not stabile in aqueous solution and degrade rapidly at ambient temperature. Degradation of polyphosphates results in unsatisfactory sensory issues in the beverage product, such as change in acidity. Also, the shelf-life of the beverage product can be compromised as the concentration of polyphosphate deteriorates.

It is therefore an object of the present invention to provide new preservative systems for use in beverages as replacements for at least one currently used preservative that has detrimental health and/or environmental effects, or lack of sufficient stability. It is further an object of the invention to provide new beverage preservative systems with improved sensory impact. It is further an object of the invention to provide preservative systems without benzoic acid and/or reduced concentrations of sorbic acid. Some countries have regulatory restrictions on the use of sorbic acid in food and beverage products wherein the permitted concentration is less than is required to inhibit the growth of spoilage microorganisms.

### SUMMARY

According to the invention, a beverage preservative system is provided which comprises: an additive or synergistic combination of at least two selected from the group consisting of trans-cinnamic acid, dimethyl dicarbonate, and lauric arginate; wherein the beverage preservative system prevents spoilage by microorganisms in a beverage within a sealed container for a period of at least 16 weeks.

According to another aspect of the invention, a beverage product is provided which comprises: a beverage component; an additive or synergistic combination of at least two selected from the group consisting of trans-cinnamic acid, dimethyl dicarbonate, and lauric arginate wherein the beverage has a pH of less than 7.5, typically a pH of 2.5 to 5.6; and the beverage when placed within a sealed container is substantially not spoiled by microorganisms for a period of at least 16 weeks. In accordance with a further aspect, the beverage is a high acid beverage having a pH of about 2.5 to about 4.6.

According to one aspect of the invention, a beverage preservative system is provided which comprises: an additive or combination of trans-cinnamic acid and dimethyl dicarbonate; wherein the beverage preservative system prevents spoilage by microorganisms in a beverage within a sealed container for a period of at least 16 weeks. Another aspect of the invention is directed to a beverage containing the beverage preservative system comprising an additive or synergistic combination of trans-cinnamic acid and dimethyl dicarbonate.

According to another aspect of the invention, a beverage preservative system is provided which comprises: an additive or synergistic combination of trans-cinnamic acid and lauric arginate; wherein the beverage preservative system prevents spoilage by microorganisms in a beverage within a sealed container for a period of at least 16 weeks. Another aspect of the invention is directed to a beverage containing the beverage preservative system comprising an additive or synergistic combination of trans-cinnamic acid and lauric arginate

According to another aspect of the invention, a beverage preservative system is provided which comprises: an additive or synergistic combination of dimethyl dicarbonate and lauric arginate; wherein the beverage preservative system prevents spoilage by microorganisms in a beverage within a sealed container for a period of at least 16 weeks. Another aspect of the invention is directed to a beverage containing the beverage preservative system comprising an additive or synergistic combination of dimethyl dicarbonate and lauric arginate

Thus, aspects of the invention are directed to additive or synergistic combinations of trans-cinnamic acid, and dimethyl dicarbonate; trans-cinnamic acid, and lauric arginate; and dimethyl dicarbonate and lauric arginate. Moreover, it is contemplated that lauric arginate may be added to the combination of trans-cinnamic acid, and dimethyl dicarbonate; dimethyl dicarbonate may be added to the combination of trans-cinnamic acid and lauric arginate; and trans-cinnamic acid may be added to the combination of dimethyl dicarbonate and lauric arginate.

These and other aspects, features, and advantages of the invention or of certain embodiments of the invention will be apparent to those skilled in the art from the following disclosure and description of exemplary embodiments.

### BRIEF DESCRIPTION OF THE DRAWINGS

FIGS. 1a-1e depict organism growth results for lauric arginate, cinnamic acid, and combinations thereof

FIGS. 2a-2d depict organism growth results for lauric arginate, cinnamic acid, DMDC, and combinations thereof.

FIGS. 3a-3e depict organism growth results for DMDC for various beverages.

FIGS. 4a-4c depict organism growth results for lauric arginate, cinnamic acid, DMDC, and combinations thereof

FIGS. 5a-5e depict organism growth results for lauric arginate, cinnamic acid, DMDC, EDTA, SHMP, and combinations thereof for an enhanced water product.

FIGS. 6a-6e depict organism growth results for lauric arginate, cinnamic acid, DMDC, AA, and combinations thereof for a green tea-type beverage.

FIGS. 7a-7e depict organism growth results for lauric arginate, cinnamic acid, DMDC, EDTA, SHMP, and combinations thereof for an energy beverage.

### DETAILED DESCRIPTION

The present invention is directed to beverage preservative systems and beverage products comprising the preservative system. Among the components of the beverage preservative system or beverage product of invention, none are able to individually inhibit the growth of all categories of spoilage microorganisms when present at concentrations employed in the present invention. Only when the components are assembled together in the present invention do they yield a cascade of bio-physical interactions that serve to disrupt the metabolism of each form of spoilage microorganisms so as to prevent their outgrowth. In some combinations, the components of the invention do not just provide an additive preservative effect, but work together in a synergistic manner to inhibit growth of spoilage microorganisms in a beverage within a sealed container for a period of at least 16 weeks. This synergy, when it occurs, is quantifiable. By virtue of the additive effects of, or synergy between, various components of the beverage preservative system of invention, a lower concentration of each component is needed than would be the case if using conventional preservatives. Thus, flavor impact of the preservative system in beverages can be reduced or minimized, and the beverage product of invention possesses surprisingly superior sensory impact, including superior flavor, aroma, and quality, compared to beverages using conventional preservatives.

Aspects of the invention are directed to combinations of at least two selected from the group consisting of trans-cinnamic acid, dimethyl dicarbonate (DMDC), and lauric arginate (LAE) as a beverage preservative system. All possess antimicrobial properties. However, all have shortcomings when used individually.

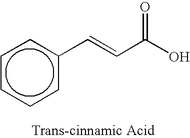

The taste threshold of trans-cinnamic acid is substantially lower than is the concentration required to inhibit the outgrowth of spoilage yeast and some bacteria. Thus, at concentrations required to inhibit the outgrowth of yeast, trans-cinnamic acid results in one or more unfavorable sensory attributes in various beverage products.

Over a period of incubation of 16 weeks, fungal strains are found to be tolerant to cinnamic acid at concentrations as high as 300 ppm, or even as high as 450 ppm cinnamic acid (pH 3.4). Thus, cinnamic acid, as a stand alone preservative, would need to be present at a concentrations as high as 450 ppm (e.g. between 450-500) in order to be assured that of preservation against spoilage by organisms such as Zygosaccharomyces bisporous and Zygosaccharomyces bailii for a period of at least 16 weeks. It should be noted that prior art has found MIC values of between 125-180ppm for Cinnamic acid when tested over a period of incubation of no greater than 72 hours. Wherein a product is batched for use within such a period, the 72 hour MIC value is relevant (as might be the case for a fountain product batched for use in a restaurant). Beverage product case packaged in a container and which must pass through lengthy channels of distribution before reaching the consumer need be stable for a period as long as 16 weeks. Hence, the relevant MIC value is that which is obtained following an incubation period of 16 weeks.

It is noted that it is the acid of cinnamic acid that possesses antimicrobial activity. The salt of the acid is more readily soluble in water. Upon acidification, the salt of cinnamic acid is converted to the acid form. Hence either the acid or salt version may be used.

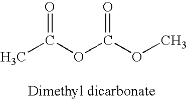

It is commonly understood that dimethyl dicarbonate is effective only toward bacterial and fungal organisms that are in the vegetative state. In and of itself, dimethyl dicarbonate is not active against the spore state of organisms. Many types of spoilage organisms are able to convert between vegetative and spore states. Spores are dormant structures consisting of a hardened coat that encompass the specific remnants of the vegetative-state. The spore state offers protection from chemical and physical agents that are lethal to vegetative forms. An organism in the spore state may germinate and resume reproduction and growth in the form of the vegetative state.

DMDC is subject to rapid decomposition in aqueous systems, and the rate of degradation is so fast that there is little chance for the action of residual DMDC with vegetative forms of mold that have evolved from the spore state. Mold spores typically require several hours to evolve to a vegetative form once initiation of germination has commenced. Spores associated with the food contact surface of packaging materials will not initiate germination until wetted by the product Thus, DMDC is typically not employed in the preservation of products that can support the growth of mold (most still beverages) andcannot be employed as a stand alone preservative because it is inactive against mold spores and it dissipates before it can act on any spores that germinate in product.

Moreover, the manufacturer of DMDC reports that the concentration of DMDC required to stabilize beverage for a period of 16 weeks against the outgrowth of vegetative forms of yeast, mold, and bacteria is at least 250 mg/liter. This is the legal limit for use inside of the U.S.

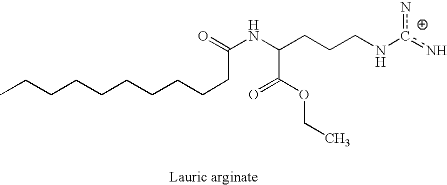

According to the inventors and manufacturers of Lauric Arginate inhibition of spoilage organisms such as Saccharomyces cerevisiae and Aspergillus niger requires a stand alone concentration of lauric arginate of between 32 & 64 ppm Penicillium, also a spoilage organism, is tolerant to concentrations of LAE between 64 ppm and 128 ppm. Moreover, the inventor & manufacturer of LAE recommend the use of a stand alone concentration of lauric arginate equal to 128 ppm to stabilize beverages against spoilage by yeast and mold weeks is at least. FDA permits the use of 200 ppm ethyl-N-lauroyl-L-argniate hydrochloride (LAE) in non-soft drink beverages. Such stand alone concentrations are problematic because of taste and because the presence of lauric arginate results in the formation of a cloud or haze in some product types. Thus, lauric arginate, at concentrations required to inhibit yeast and bacteria in beverages, imparts unfavorable sensory attributes to various beverage products because the taste threshold of lauric arginate is substantially lower than is the concentration required to inhibit the outgrowth of spoilage yeast and some bacteria.

The invention described herein is based on an additive or synergistic interaction between of at least two selected from the group consisting of trans-cinnamic acid, dimethyl dicarbonate (DMDC), and lauric arginate (LAE) that is effective in preventing the outgrowth of spoilage yeast, fungi and bacteria in a beverage product, for a period of at least 16 weeks regardless of the existence of spore states at the time of dosing. At least two components are combined in specific ranges of concentrations for the purpose of prohibiting outgrowth of spoilage organisms while also allowing for the formulation of a product that is well received by the consumer. The invention also permits the use of LAE, DMDC, and Cinnamic acid or its salts in combination with each other in order to affect the additive or synergistic effect.

It was not expected that such combinations would have been suitable preservative system for beverages. For example, it was believed that a chemical reaction between DMDC and LAE could result in the inactivation of one or both of these substances. The possible inactivation mechanism would be a result of enhanced rate of degradation of DMDC in the presence of a surfactant such as (LAE) or even a direct reaction between the amine group of LAE and DMDC. Although, not highly probable, there was also some concern about a reaction between the hydroxyl portion of the carboxylic acid of trans-cinnamic acid. Mechanisms of decay that of DMDC that might impact efficacy of the preservation system can be summarized as:

DMDC+H₂O→2CH₃OH+2CO₂

DMDC+ROOH→ROCOCH₃

DMDC+RNH₂→RNH₂OCOCH₃

DMDC+Amino Acid→Derived carboxymethyl

In addition, it was believed, for example, that DMDC might interact with other components typically employed in preservative systems such as EDTA or EDDS. Both of these substances possess amine groups. Thus, one skilled in the art would not have combined such components due to the potential adverse reactions.

Thus, aspects of the invention are directed to the additive and synergistic combinations of trans-cinnamic acid, and dimethyl dicarbonate; trans-cinnamic acid, and lauric arginate; and dimethyl dicarbonate and lauric arginate. Moreover, it is contemplated that lauric arginate may be added to the combination of trans-cinnamic acid, and dimethyl dicarbonate; dimethyl dicarbonate may be added to the combination of trans-cinnamic acid and lauric arginate; and trans-cinnamic acid may be added to the combination of dimethyl dicarbonate and lauric arginate.

Aspects of the invention utilize trans-cinnamic acid at a concentration of no greater than about 50 ppm, generally between about 0.1 ppm to about 50 ppm, about 1 ppm to about 40 ppm, about 2 ppm to about 35 ppm, about 2.5 ppm and about 30 ppm.

Aspects of the invention utilize lauric arginate at a concentration of no greater than about 25 ppm, or about 1 to about 25 ppm, generally between about 2 ppm and about 10 ppm, or between about 5 and about 8 ppm.

Both trans-cinnamic acid and lauric arginate are preferably employed in very low concentrations (preferably 30 ppm or less) to ensure that their concentrations do not exceed the taste threshold. Such concentrations are much lower than the concentration reported to be necessary to inhibit the outgrowth of spoilage organisms.

Aspects of the invention utilize DMDC at a concentration of between about 25 and about 250 ppm, about 50 ppm to about 200 ppm, about 75 ppm and about 200 ppm, or between about 100 ppm and about 200 ppm.

Aspects of the invention are directed to preserve a broad range of beverage products that possess a pH of less than 7.5, in particular less than about 4.6, such as 2.5 to 4.6 against spoilage by yeast, mold and a range of acid tolerant bacteria. Preservation of product can be accomplished merely through the addition of the chemical agents described herein, but it is also possible to supplement the action of the chemicals with purely physical forms of preservation such as alteration of product temperature, various wavelengths of irradiation, pressure or combinations thereof. In certain exemplary embodiments, the pH of the beverage product comprising the preservative system is e.g., about 4.6 or less, about 2.5 to about 4.4, about 2.6 to about 4.5.

The pH of the preservative system in and of itself is not particularly relevant. Only a very small amount will be added to beverage and the pH of the beverage will dominate. The pH of the beverage containing the preservative system can be adjusted to any specified value.

The beverage preservative system may have sequestrants such as ethylene diamine tetraacetic acid (EDTA) or ethylene diamine-N,N′-disuccinic acid (EDDS) a disphosphonic acid or a polyphosphate to bind trace metals that otherwise enhance tolerance to preservatives that are able to disrupt cellular functions of spoilage organisms. Either EDTA or EDDS will work additively with polyphosphates or bis-phosphonates to compromise the integrity of the cell envelop allowing enhanced permeation of trans-cinnamic acid, lauric arginate and or DMDC. Addition of such sequestrants is limited by the regulatory agencies. For example, the limit of EDTA is 30 ppm and EDDS is 450 ppm. Unless a beverage is supplemented with a trace metal (i.e. chromium) or contains greater than 10% juice, these quantities of EDTA and EDDS are sufficient to sequester metals of concern in most beverage products.

Polyphosphates can be added to beverage products up to 1500 ppm and diphosphonic acids can be added in amounts in amounts of at least 500 ppm (when approved.)

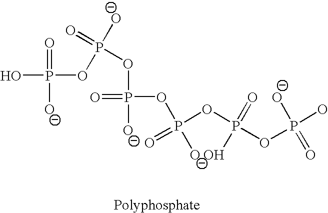

Non-exhaustive examples of bisphosphonic acid chelates include the following:

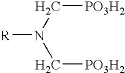

where R is:
C₆H₁₁ N-Cyclohexyliminodi(methylenephosphonic) acid
(CH₃)₂CH(CH₂)₂— N-iso-pentylimindi(methylenephosphonic acid)
CH₃CH₂— N-methyliminodi(methylenephosphonic acid)
CH₃— N-methyliminodi(methylenephosphonic acid)
(C₆H₅)CH₂— N-3-benzyliminodi(methylenephosphonic acid)
(CH₃)₂CH(CH₂)₂— N-iso-penyliminodi(methylenephosphonic acid)

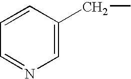

N-3-picolyliminodi(methylenephosphonic acid)

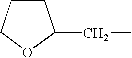

N-2-methyltetrahydrofurliminodi(methylenephosphonic acid)

Other forms of bis-phosphonates include

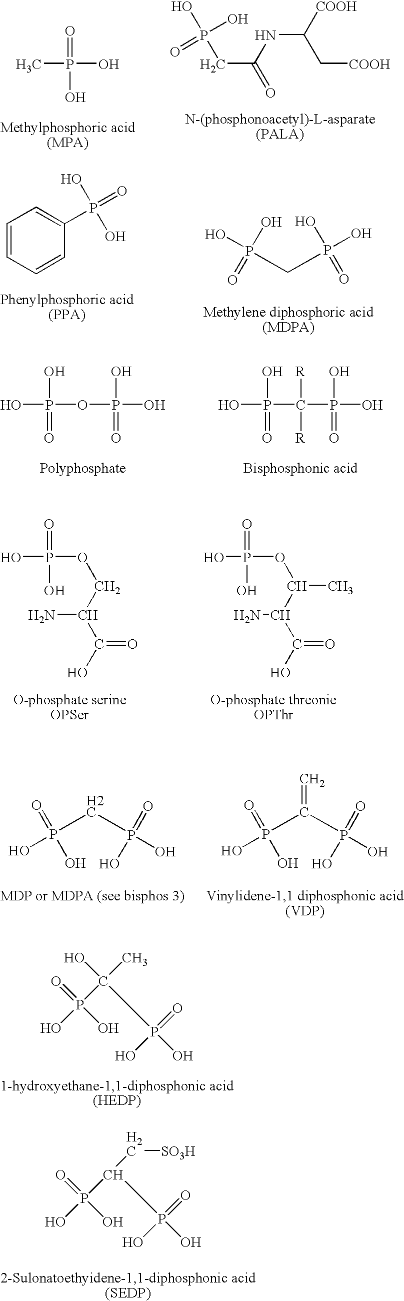

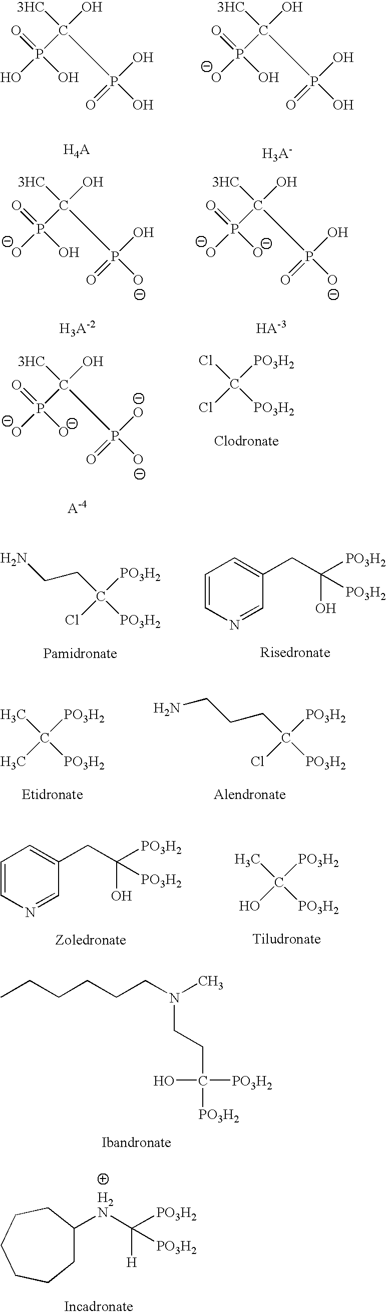

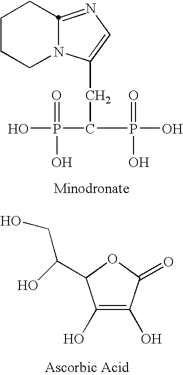

Ascorbic acid may be incorporated as part of the microbiological chemical preservation system. Ascorbic acid is not generally considered an antimicrobial. Instead, ascorbic acid is understood to “preserve” food ingredients against oxidation. In this respect, ascorbic acid is understood to be “anti-oxidant” preservative. However, Pepsi R&D has developed data indicating a role for vitamin C (ascorbic acid) in the prevention of spoilage by mold. In combination with 50, 100 or 180 ppm Potassium Sorbate, concentrations of ascorbic acid in the range of 50-400 ppm serves to inhibit the germination of spores of bio-indicator strain mold spores (Byssochlamyus nieva and Paecilomyces variotti). Alone, Potassium sorbate is unable to prevent spore germination at concentrations below 200 ppm. In that ascorbic acid alone at 400 ppm is also able to retard germination, it is clear that the action of ascorbic acid is not merely to prevent oxidation of sorbic acid.

Because ascorbic acid possesses the capacity to retard spore germination, the invention anticipates that the combination of ascorbic acid with either LAE, Cinnamic acid or LAE and Cinnamic acid will result in an enhanced chemical preservation system.

In general, the beverage preservative system or beverage product of invention should have a total concentration of chromium, aluminum, nickel, zinc, copper, manganese, cobalt, calcium, magnesium, and iron cations in the range of about 1.0 mM or less, e.g., about 0.5 mM to 0.75 mM, about 0.54 mM or less. The present invention may optionally include the use water to batch product that has been treated to remove metal cations. As opposed to the teachings of U.S. Pat. No. 6,268,003, the preferred method of treatment is via physical processes reverse osmosis and or electro-deionization. Treatment by chemical means, as taught in U.S. Pat. No. 6,268,003 is acceptable, but is not preferred. The use of chemical means to reduce water hardness often results in an increase in the concentration of specific mono-valent cations, e.g., potassium cations, that serve to compromise the invention described herein. In certain exemplary embodiments, the added water has been treated by reverse osmosis, electro-deionization or both to decrease the total concentration of metal cations of chromium, aluminum, nickel, zinc, copper, manganese, cobalt, calcium, magnesium, and iron to about 1.0 mM or less.

As commonly understood in the art, the definitions of the terms “preserve,” “preservative,” and “preservation” do not provide a standard time period for how long the thing to be preserved is kept from spoilage, decomposition, or discoloration. The time period for “preservation” can vary greatly depending on the subject matter. Without a stated time period, it can be difficult or impossible to infer the time period required for a composition to act as a “preservative.”

As used herein, the terms “preserve,” “preservative,” and “preservation” refer to a food or beverage product protected against or a composition able to stop or completely prevent spoilage of a product that is the result of the growth of spoilage microorganisms for a period of at least 16 weeks. This period is in keeping with the time required to transport a beverage product from location of manufacture, through distribution channels, into the hand of the consumer. Absence of spoilage is noted by absence any evidence of growth of spoilage organisms (turbidity, viable count, direct microscopic count or other standard methods of enumeration) and by the absence of any discernable change in the product attributes that could be routinely attributed to metabolism of spoilage organisms.

As employed in writing, tables or graphs of this document, the word “inhibit” is understood to mean stop or to prevent completely. This clarification seems relevant in that the general meaning of the word “inhibit” is ambiguous at best and is employed in formal writing to mean nearly any degree of constraint.

Typically, the product is preserved under ambient conditions, which include the full range of temperatures experienced during storage, transport, and display (e.g., 0° C. to 40° C., 10° C. to 30° C., 20° C. to 25° C.) without limitation to the length of exposure to any given temperature.

“Minimal inhibitory concentration” (MIC) is another term for which no standard time period is routinely defined or understood. In the medical fields, MIC is frequently employed to designate the concentration of a substance which prohibits the growth of a single type of microorganism in over-night incubation as compared to a positive control without the substance (see Wikipedia). However, the rest of the scientific community has adopted the term MIC to mean any of a number of conditions of period of incubation and degree of inhibition.

Even within the medical field, it is recognized that an MIC value developed over a period of 24 hours incubation may not be the same value developed after 48 hours or longer. Otherwise stated, a substance may exhibit an observable MIC during the first 24 hours of an experiment, but exhibit no measurable MIC relative to the positive control after 48 hours.

Beverage products according to the present invention include both still and carbonated beverages. Herein, the term carbonated beverage is inclusive of any combination of water, juice, flavor and sweetener that is meant to be consumed as an alcohol free liquid and which also is made to possess a carbon dioxide concentration of 0.2 volumes of CO₂ or greater. The term “volume of CO₂” is understood to mean a quantity of carbon dioxide absorbed into the liquid wherein one volume CO₂ is equal to 1.96 grams of carbon dioxide (CO₂) per liter of product (0.0455M) at 25° C. Non-inclusive examples of carbonated beverages include flavored seltzer waters, juices, cola, lemon-lime, ginger ale, and root beer beverages which are carbonated in the manner of soft drinks, as well as beverages that provide health or wellness benefits from the presence of metabolically active substances, such as vitamins, amino acids, proteins, carbohydrates, lipids, or polymers thereof. Such products may also be formulated to contain milk, coffee, or tea or other botanical solids. It is also possible to formulate such beverages to contain one or more nutraceuticals. Herein, a nutraceutical is a substance that has been shown to possess, minimally, either a general or specific health benefit or sense of wellness as documented in professional journals or texts. Nutraceuticals, however, do not necessarily act to either cure or prevent specific types of medical conditions.

Herein, the term “still beverage” is any combination of water and ingredient which is meant to be consumed in the manner of an alcohol free liquid beverage and which possesses no greater than 0.2 volumes of carbon dioxide. Non-inclusive examples of still beverages include flavored waters, tea, coffee, nectars, mineral drinks, sports beverages, vitamin waters, juice-containing beverages, punches or the concentrated forms of these beverages, as well as beverage concentrates which contain at least about 45% by weight of juice. Such beverages may be supplemented with vitamins, amino acids, protein-based, carbohydrate-based or lipid-based substances. As noted, the invention includes juice containing products, whether carbonated or still. “Juice containing beverages” or “Juice beverages”, regardless of whether still or carbonated, are products containing some or all the components of a fruit, vegetable or nuts or mixture thereof that can either be suspended or made soluble in the natural liquid fraction of the fruit.

The term “vegetable,” when used herein, includes both fruiting and the non-fruiting but edible portion of plants such as tubers, leaves, rinds, and also, if not otherwise indicated, any grains, nuts, beans, and sprouts which are provided as juices or beverage flavorings. Unless dictated by local, national or regional regulatory agencies the selective removal of certain substances (pulp, pectins, etc) does not constitute an adulteration of a juice.

By way of example, juice products and juice drinks can be obtained from the fruit of apple, cranberry, pear, peach, plum, apricot, nectarine, grape, cherry, currant, raspberry, goose-berry, blackberry, blueberry, strawberry, lemon, orange, grapefruit, passionfruit, mandarin, mirabelle, tomato, lettuce, celery, spinach, cabbage, watercress, dandelion, rhubarb, carrot, beet, cucumber, pineapple, custard-apple, coconut, pomegranate, guava, kiwi, mango, papaya, watermelon, lo han guo, cantaloupe, pineapple, banana or banana puree, lemon, mango, papaya, lime, tangerine, and mixtures thereof. Preferred juices are the citrus juices, and most preferred are the non-citrus juices, apple, pear, cranberry, strawberry, grape, papaya, mango and cherry.

The invention could be used to preserve a formulation that is essentially 100% juice but the product cannot be labeled to contain 100% juice. The invention can be used in products containing juice wherein juice concentration is below 100%. Lowering of juice concentration below 10% will typically favor the use of lowered concentrations of preservatives. Formulations containing juice concentrations as high as 10% may be preserved by this invention and certainly a beverage containing less than 10% juice would be preserved by this invention a beverage containing no more than 5% juice would be preserved by this invention. Any juice can be used to make the beverage of this invention. If a beverage concentrate is desired, the fruit juice is concentrated by conventional means from about 12° Brix to about 65° Brix. Beverage concentrates are usually 40° Brix or higher (about 40% to about 75% sugar solids).

Typically, beverages will possess a specified range of acidity. Acidity of a beverage is largely determined by the type of acidulant, its concentration, and the propensity of protons associated with the acid to dissociate away from the acid when the acid is entered into solution (pk_{A}). Any solution with a measurable pH between 0-14 possesses some, as reflected in the measurable or calculable concentration of free protons. However, those solutions with pH below 7 are generally understood to be acidic and those above pH 7 are understood to be basic. The acidulant can be organic or inorganic. A non-exclusive example of inorganic acids is phosphoric acids. Non-exclusive examples of organic acids are citric, malic, ascorbic, tartaric, lactic, gluconic, and succinic acids. Non-exclusive examples of inorganic acids are the phosphoric acid compounds and the mono- and di-potassium salts of these acids. (Mono- and di-potassium salts of phosphoric acid possess at least one proton that can contribute to acidity).

The various acids can be combined with salts of the same or different acids in order to manage pH or the buffer capacity of the beverage to a specified pH or range of pH. The invention can function at a pH as low as 2.6, but the invention will better function as the pH is increased from 2.6 up to pH 7.2. For high acidic beverages, the invention is not limited by the type of acidulant employed in acidifying the product. Virtually any organic acid salt can be used so long as it is edible and does not provide an off-flavor. The choice of salt or salt mixture will be determined by the solubility and the taste. Citrate, malate and ascorbate yield ingestible complexes whose flavors are judged to be quite acceptable, particularly in fruit juice beverages. Tartaric acid is acceptable, particularly in grape juice beverages, as is lactic acid. Longer-chain fatty acids may be used but can affect flavor and water solubility. For essentially all purposes, the malate, gluconate, citrate and ascorbate moieties suffice.

Certain exemplary embodiments of the beverage product of invention include sports (electrolyte balancing) beverages (carbonated or non-carbonated). Typical sport beverages contain water, sucrose syrup, glucose-fructose syrup, and natural or artificial flavors. These beverages can also contain sodium chloride, citric acid, sodium citrate, mono-potassium phosphate, as well as other natural or artificial substances which serve to replenish the balance of electrolytes lost during perspiration.

In certain exemplary embodiments, the present invention also includes beverage formulations supplemented with fat soluble vitamins. Non-exclusive examples of vitamins include fat-soluble vitamin E or its esters, vitamin A or its esters, vitamin K, and vitamin D3, especially vitamin E and vitamin E acetate. The form of the supplement can be powder, gel or liquid or a combination thereof. Fat-soluble vitamins may be added in a restorative amount, i.e. enough to replace vitamin naturally present in a beverage such as juice or milk, which may have been lost or inactivated during processing. Fat-soluble vitamins may also be added in a nutritionally supplemental amount, i.e. an amount of vitamin considered advisable for a child or adult to consume based on RDAs and other such standards, preferably from about one to three times the RDA (Recommended Daily Amount). Other vitamins which can be added to the beverages include vitamin B niacin, pantothenic acid, folic acid, vitamin D, vitamin E, vitamin B and thiamine. These vitamins can be added at levels from 10% to 300% RDA.

Supplements: The invention can be compromised by the presence of certain types of supplements but it is not an absolute and it will vary from beverage formulation to beverage formulation. The degree to which the invention is compromised will depend on the nature of the supplement and the resulting concentration of specific metal cations in the beverage as a consequence of the presence of the supplement. For example, calcium supplements can compromise the invention, but not to the same degree as chromium supplements. Calcium supplements may be added to the degree that a critical value total calcium concentration is not exceeded Calcium sources that are compatible with the invention include calcium organic acid complexes. Among the preferred calcium sources is “calcium citrate-malate”, as described in U.S. Pat. No. 4,786,510 and U.S. Pat. No. 4,786,518 issued to Nakel et al. (1988) and U.S. Pat. No. 4,722,847 issued to Heckert (1988). Other calcium sources compatible with the invention include calcium acetate, calcium tartrate, calcium lactate, calcium malate, calcium citrate, calcium phosphate, calcium orotate, and mixtures thereof. Calcium chloride and calcium sulfate can also be included; however at higher levels they taste astringent.

Flavor Component: Beverage products according to the present invention can contain flavors of any type. The flavor component of the present invention contains flavors selected from artificial, natural flavors, botanical flavors fruit flavors and mixtures thereof. The term “botanical flavor” refers to flavors derived from parts of a plant other than the fruit; i.e. derived from bean, nuts, bark, roots and leaves. Also included within the term “botanical flavor” are synthetically prepared flavors made to simulate botanical flavors derived from natural sources. Examples of such flavors include cocoa, chocolate, vanilla, coffee, kola, tea, and the like. Botanical flavors can be derived from natural sources such as essential oils and extracts, or can be synthetically prepared. The term “fruit flavors” refers to those flavors derived from the edible reproductive part of a seed plant, especially one having a sweet pulp associated with the seed. Also included within the term “fruit flavor” are synthetically prepared flavors made to simulate fruit flavors derived from natural sources.

Artificial flavors can also be employed. Non-exclusive examples of artificial flavors include chocolate, strawberry, vanilla, cola, or artificial flavors that mimic a natural flavor can be used to formulate a still or carbonated beverage flavored to taste like fruit. The particular amount of the flavor component effective for imparting flavor characteristics to the beverage mixes of the present invention (“flavor enhancing”) can depend upon the flavor(s) selected, the flavor impression desired, and the form of the flavor component. The flavor component can comprise at least 0.005% by weight of the beverage com position.

On a case by case basis, the beverage preservative system according to the present invention is compatible with beverages formulated to contain aqueous essence. As used herein, the term “aqueous essence” refers to the water soluble aroma and flavor materials which are derived from fruit juices. Aqueous essences can be fractionated, concentrated or folded essences, or enriched with added components. As used herein, the term “essence oil” refers to the oil or water insoluble fraction of the aroma and flavor volatiles obtained from juices. Orange essence oil is the oily fraction which separates from the aqueous essence obtained by evaporation of orange juice. Essence oil can be fractionated, concentrated or enriched. As used herein, the term “peel oil” refers to the aroma and flavor derived from oranges and other citrus fruit and is largely composed of terpene hydrocarbons, e.g. aliphatic aldehydes and ketones, oxygenated terpenes and sesquiterpenes. From about 0.002% to about 1.0% of aqueous essence and essence oil are used in citrus flavored juices.

Sweetener Component: The microbiological preservation function of the present invention in single strength beverage formulation is not affected by the type of sweeteners present in the beverage. The sweetener may be any sweetener commonly employed for use in beverages. The sweetener can include a monosaccharide or a disaccharide. A certain degree of purity from contamination by metal cations will be expected. Peptides possessing sweet taste are also permitted. The most commonly employed saccharides include sucrose, fructose, dextrose, maltose and lactose and invert sugar. Mixtures of these sugars can be used. Other natural carbohydrates can be used if less or more sweetness is desired. Other types of natural sweeteners structured from carbon, hydrogen and oxygen, e.g., rebaudioside A, stevioside, Lo Han Guo, mogroside V, monatin, can also be used. The present invention is also compatible with artificial sweeteners. By way of example, artificial sweeteners include saccharin, cyclamates, acetosulfam, mogroside, Laspartyl-L-phenylalanine lower alkyl ester sweeteners (e.g. aspartame), L-aspartyl-D-alanine amides as disclosed in U.S. Pat. No. 4,411,925 to Brennan et al. (1983), L-aspartyl-D-serine amides as disclosed in U.S. Pat. No. 4,399,163 to Brennan et al., (1983), L-aspartyl-L-lhydroxymethyl alkaneamide sweeteners as disclosed in U.S. Pat. No. 4,338, 346 to Brand, issued Dec. 21, 1982, L-aspartyl-1-hydroxy ethylakaneamide sweeteners as disclosed in U.S. Pat. No. 4,423,029 to Rizzi, (1983), L-aspartyl-D-phenylglycine ester and amide sweeteners as disclosed in European Patent Application 168,112 to J. M. Janusz, published Jan. 15, 1986, and the like. A particularly preferred sweetener is aspartame. The amount of the sweetener effective in the beverage mixes of the invention depends upon the particular sweetener used and the sweetness intensity desired.

Head space atmosphere: The presence of air in the headspace of the beverage product will have no measurable impact on the composition of the invention. The presence of carbon dioxide gas or other gases that cause the exclusion of oxygen from the beverage (nitrogen, nitrous oxide, etc) may permit the use of reduced concentrations of chemical preservatives employed along with the sequestrants. The concentration of sequestrants required will be dictated only by the type and amount of metal cations that are present in the beverage product.

Generally the beverage is heated to above 71° C., cooled to no greater than 76° C. and filled into a container such that no part of container exceeds about 71° C.

The following example is a specific embodiment of the present invention, but is not intended to limit it. Any patent document referenced herein is incorporated in its entirety for all purposes.

### Example 1

Trans-cinnamic acid and lauric arginate were combined in the following beverage formulation:

| Ingredient | % total weight |
|---|---|
| Apple Juice | Dilu to 10% of single |
| Concentrate | strength |
| Malic Acid | 0.056% |
| Dextrose | 4.6% |
| Sucrose | 0.18% |
| Fructose | 5.94% |
| Batch Water | Make to 100% |

Results showed that the interactions between the two are unexpectedly strong. The beverage formulation shown in the table above was found to be stable against spoilage of Zvgosaccharomyces bailii, Brettanomyces bruxellensus, and Brettanomyces nardensis in the presence of a mixture of lauric arginate and cinnamic acid wherein the concentration of these substances is quite low relative to the stand alone concentrations of these substances.

### Zvaosaccharomvces bailii

| | Combination of LAE & Cinnamic Acid | | | | | |
|---|---|---|---|---|---|---|
| | [Cinnamic Acid] ppm | | | | | |
| [LAE] ppm | 0 | 10 | 20 | 50 | 75 | 100 |
| PH 3.0 | | | | | | |
| 0 | 100% | 89% | 82% | 85% | 45% | 36% |
| 2.5 | 81% | 83% | 73% | 56% | 34% | 13% |
| 5 | 88% | 77% | 69% | 31% | 7% | 3% |
| 7.5 | 82% | 78% | 73% | 5% | 2% | 1% |
| 10 | 79% | 66% | 42% | 1% | 0% | 0% |
| 15 | 75% | 55% | 2% | 0% | 0% | 0% |
| PH 3.5 | | | | | | |
| 0 | 100% | 97% | 92% | 76% | 57% | 48% |
| 2.5 | 95% | 85% | 80% | 62% | 36% | 21% |
| 5 | 75% | 73% | 73% | 47% | 13% | 5% |
| 7.5 | 75% | 76% | 70% | 38% | 6% | 2% |
| 10 | 78% | 72% | 69% | 17% | 4% | 0% |
| 15 | 86% | 79% | 63% | 1% | 0% | 0% |
| PH 4.0 | | | | | | |
| 0 | 100% | 103% | 94% | 78% | 74% | 56% |
| 2.5 | 94% | 88% | 83% | 66% | 45% | 29% |
| 5 | 80% | 88% | 80% | 53% | 25% | 11% |
| 7.5 | 85% | 84% | 83% | 48% | 19% | 8% |
| 10 | 114% | 111% | 103% | 41% | 9% | 3% |
| 15 | 124% | 112% | 86% | 13% | 2% | 1% |

Values reflect amount of growth (normalized) to control (0 ppm LAE & 0 ppm Cinnamic acid) for each pH tested. Growth response of 0-1% is considered negative for growth.

### Brettanomvces bruxellensus

| | Combination of LAE & Cinnamic Acid | | | | | |
|---|---|---|---|---|---|---|
| | [Cinnamic Acid] ppm | | | | | |
| [LAE] ppm | 0 | 10 | 20 | 50 | 75 | 100 |
| PH 3.0 | | | | | | |
| 0 | 100% | 85% | 82% | 4% | 1% | 1% |
| 2.5 | 97% | 105% | 91% | 1% | 1% | 1% |
| 5 | 101% | 112% | 69% | 0% | 1% | 0% |
| 7.5 | 96% | 112% | 10% | 1% | 0% | 0% |
| 10 | 102% | 108% | 6% | 0% | 0% | 0% |
| 15 | 94% | 32% | 0% | 0% | 0% | 0% |
| PH 3.5 | | | | | | |
| 0 | 100% | 90% | 89% | 27% | 0% | 0% |
| 2.5 | 96% | 96% | 91% | 0% | 1% | 0% |
| 5 | 106% | 107% | 79% | 0% | 0% | 1% |
| 7.5 | 110% | 107% | 67% | 1% | 1% | 1% |
| 10 | 114% | 102% | 60% | 0% | 1% | 0% |
| 15 | 118% | 92% | 3% | 0% | 0% | 0% |
| PH 4.0 | | | | | | |
| 0 | 100% | 99% | 96% | 65% | 1% | 1% |
| 2.5 | 115% | 114% | 106% | 5% | 1% | 1% |
| 5 | 125% | 131% | 47% | 0% | 0% | 1% |
| 7.5 | 124% | 121% | 97% | 0% | 1% | 1% |
| 10 | 124% | 121% | 15% | 0% | 0% | 0% |
| 15 | 131% | 106% | 0% | 0% | 0% | 1% |

Values reflect amount of growth (normalized) to control (0 ppm LAE & 0 ppm Cinnamic acid) for each pH tested. Growth response of 0-1% is considered negative for growth.

### Brettanomvces nardensis

| | Combination of LAE & Cinnamic Acid | | | | | |
|---|---|---|---|---|---|---|
| | [Cinnamic Acid] ppm | | | | | |
| [LAE] ppm | 0 | 10 | 20 | 50 | 75 | 100 |
| PH 3.0 | | | | | | |
| 0 | 100% | 89% | 67% | 1% | 0% | 0% |
| 2.5 | 89% | 100% | 65% | 0% | 0% | 0% |
| 5 | 116% | 68% | 8% | 0% | 0% | 0% |
| 7.5 | 90% | 2% | 0% | 0% | 0% | 0% |
| 10 | 99% | 0% | 0% | 0% | 0% | 0% |
| 15 | 0% | 0% | 0% | 0% | 0% | 0% |
| PH 3.5 | | | | | | |
| 0 | 100% | 88% | 79% | 2% | 1% | 1% |
| 2.5 | 112% | 102% | 76% | 1% | 1% | 1% |
| 5 | 86% | 90% | 40% | 1% | 0% | 0% |
| 7.5 | 81% | 23% | 2% | 0% | 0% | 0% |
| 10 | 57% | 2% | 1% | 0% | 0% | 0% |
| 15 | 0% | 0% | 0% | 0% | 0% | 0% |
| PH 4.0 | | | | | | |
| 0 | 100% | 118% | 101% | 5% | 2% | 1% |
| 2.5 | 109% | 111% | 101% | 3% | 1% | 1% |
| 5 | 104% | 104% | 58% | 1% | 0% | 1% |
| 7.5 | 97% | 91% | 22% | 0% | 1% | 0% |
| 10 | 0% | 1% | 0% | 0% | 0% | 0% |
| 15 | 0% | 0% | 0% | 0% | 0% | 0% |

Values reflect amount of growth (normalized) to control (0 ppm LAE & 0 ppm Cinnamic acid) for each pH tested. Growth response of 0-1% is considered negative for growth.

| | Lauric Arginate: 0 ppm | | | | | |
|---|---|---|---|---|---|---|
| | [Cinnamic Acid] ppm | | | | | |
| [LAE] ppm | 0 | 10 | 20 | 50 | 75 | 100 |
| PH 3.0 | | | | | | |
| 0 | 100% | 80% | 74% | 50% | 26% | 11% |
| 2.5 | 97% | 82% | 73% | 43% | 20% | 7% |
| 5 | 97% | 75% | 56% | 27% | 6% | 0% |
| 7.5 | 86% | 59% | 49% | 6% | 0% | 0% |
| 10 | 94% | 45% | 3% | 1% | 0% | 0% |
| 15 | 42% | 0% | 0% | 0% | 0% | 0% |
| PH 3.5 | | | | | | |
| 0 | 100% | 96% | 85% | 61% | 44% | 22% |
| 2.5 | 103% | 89% | 79% | 53% | 32% | 15% |
| 5 | 104% | 86% | 76% | 40% | 16% | 5% |
| 7.5 | 93% | 78% | 59% | 24% | 4% | 0% |
| 10 | 105% | 69% | 52% | 11% | 0% | 0% |
| 15 | 57% | 0% | 0% | 0% | 0% | 0% |
| PH 4.0 | | | | | | |
| 0 | 100% | 96% | 87% | 72% | 54% | 39% |
| 2.5 | 101% | 93% | 88% | 67% | 47% | 30% |
| 5 | 96% | 93% | 83% | 55% | 31% | 11% |
| 7.5 | 91% | 86% | 81% | 52% | 23% | 7% |
| 10 | 90% | 79% | 70% | 18% | 1% | 0% |
| 15 | 79% | 62% | 50% | 1% | 0% | 0% |

Values reflect amount of growth (normalized) to control (0 ppm LAE & 0 ppm Cinnamic acid) for each pH tested. Growth response of 0-1% is considered negative for growth.

The analysis of the interaction between lauric arginate and cinnamic acid can be refined through use of a mathematical method developed by Voorspuij and Nass (Arch. Int. pharmacodyn. 59:211 1957) (generally accepted among those practiced in the art.) Herein, the interactions between two active substances can be explored. First the quantity (Qa=Molar Cone) of compound A required for an end point (concentration required to stabilize product for 16 weeks) is established. Similarly, the quantity (Qb =Molar cone) of substance B required to establish the same endpoint is established. Thereafter, mixtures of A & B, in quantities QA & Qs are established that also define endpoints. The quantity log (QA+Qs/Qa+Qb) yields a value that is 0, greater than 1 or less than 1. If the sum of the ratios for a mixture of A & Bare=1, then the interaction is considered additive. A value>1 suggests antagonistic interactions and a value of <1 indicates a synergistic interaction.

1. A value of 1 as established through the equation indicate that two substances. A & B mixed in a given proportion yield a performance equal to the sum of the partial performances of the components in the mixture. (- the whole is equal to the sum of the parts).

2. A value of >than 1 as established by the equation indicates that two substances. A & B mixed in a given proportion yield a performance smaller than the sum of the partial performances of the components present in the mixture. In other words, the whole is less than the sum of the parts and the interaction between A & B is antagonistic.

3. A value of <than 1 as established by the equation indicates that the two substances A & B mixed in a given proportion yield a performance greater than the sum of the partial performances of the components present in the mixture. In this event, i.e the mixture shows a surprisingly great performance, Voorspuij and Nass wish to speak of synergism because the notion is generally used in the physical sciences for a surprisingly great performance.
Upon completion of the appropriate calculations, it was discovered that the interaction between lauric arginate and trans-cinnamic acid is synergistic. Such results are surprising and are wholly unexpected. The tables below show results from the analysis for lauric arginate and trans-cinnamic acid.

Calculation of log (QA/Qa+QB/Qb) for LAE+trans Cinnamic Acid vs Zygosaccharomyces bailii

Q_{LAE}* 76
Q_{CA}* 300

| | | | | | | | | log |
|---|---|---|---|---|---|---|---|---|
| | | Q_{LAE} + | | | | | QA/Qa + | (QA/Qa + |
| Q_{LAE} | Q_{CA}* | Q_{CA} | % LAE | % PS | Q_{LAE}/Q_{LAE}* | Q_{NaB}/Q_{NAB}* | QB/Qb | QB/Qb) |
| 0 | 300 | 300 | 0.00% | 100% | 0.00 | 1.00 | 1.00 | 0.0000 |
| 10 | 50 | 60 | 16.67% | 83.33% | 0.13 | 0.17 | 0.30 | −0.5242 |
| 15 | 50 | 65 | 23.08% | 76.92% | 0.2 | 0.17 | 0.36 | −0.4389 |
| 15 | 50 | 65 | 23.08% | 76.92% | 0.2 | 0.17 | 0.36 | −0.4389 |
| 76 | 0 | 76 | 100.00% | 0.00% | 1.00 | 0.00 | 1.00 | 0.0000 |

Calculation of log (QA/Qa+QB/Qb) for LAE+trans Cinnamic Acid vs Brettanomyces nardensis

Q_{LAE}* 15
Q_{CA}* 50

| | | | | | | | | log |
|---|---|---|---|---|---|---|---|---|
| | | Q_{LAE} + | | | | | QA/Qa + | (QA/Qa + |
| Q_{LAE} | Q_{CA}* | Q_{CA} | % LAE | % PS | Q_{LAE}/Q_{LAE}* | Q_{NaB}/Q_{NAB}* | QB/Qb | QB/Qb) |
| 0 | 50 | 50 | 0.00% | 100% | 0.00 | 1.00 | 1.00 | 0.0000 |
| 2.5 | 50 | 52.5 | 4.76% | 95.24% | 0.17 | 1.00 | 0.17 | 0.0669 |
| 5 | 50 | 55 | 9.09% | 90.91% | 0.33 | 1.00 | 1.33 | 0.1249 |
| 7.5 | 20 | 27.5 | 27.27% | 72.73% | 0.50 | 0.40 | 0.90 | −0.0458 |
| 15 | 0 | 15 | 100.00% | 0.00% | 1.00 | 0.00 | 1.00 | 0.0000 |

Calculation of log (QA/Qa+QB/Qb) for LAE+trans Cinnamic Acid vs Brettanomyces bruzellensus

Q_{LAE}* 30
Q_{CA}* 75

| | | | | | | | | log |
|---|---|---|---|---|---|---|---|---|
| | | Q_{LAE} + | | | | | QA/Qa + | (QA/Qa + |
| Q_{LAE} | Q_{CA}* | Q_{CA} | % LAE | % PS | Q_{LAE}/Q_{LAE}* | Q_{NaB}/Q_{NAB}* | QB/Qb | QB/Qb) |
| 0 | 75 | 75 | 0.00% | 100% | 0.00 | 1.00 | 1.00 | 0.0000 |
| 2.5 | 50 | 52.5 | 4.76% | 95.24% | 0.08 | 0.67 | 0.75 | −0.1249 |
| 5 | 50 | 55 | 9.09% | 90.91% | 0.17 | 0.67 | 0.83 | −0.0792 |
| 7.5 | 50 | 57.5 | 13.04% | 86.96% | 0.25 | 0.67 | 0.92 | −0.0378 |
| 10 | 50 | 60 | 16.67% | 83.33% | 0.33 | 0.67 | 1.00 | 0.0000 |
| 15 | 20 | 35 | 42.86% | 57.14% | 0.50 | 0.00 | 0.77 | −0.1154 |

Calculation of log (QA/Qa+QB/Qb) for LAE+trans Cinnamic Acid vs Saccharomyces cerevsiae

Q_{LAE}* 32
Q_{CA}* 300

| | | | | | | | | log |
|---|---|---|---|---|---|---|---|---|
| | | Q_{LAE} + | | | | | QA/Qa + | (QA/Qa + |
| Q_{LAE} | Q_{CA}* | Q_{CA} | % LAE | % PS | Q_{LAE}/Q_{LAE}* | Q_{NaB}/Q_{NAB}* | QB/Qb | QB/Qb) |
| 0 | 300 | 300 | 0.00% | 100.00% | 0.00 | 1.00 | 1.00 | 0.0000 |
| 2.5 | 100 | 102.5 | 2.44% | 97.56% | 0.08 | 0.33 | 0.41 | −0.3857 |
| 5 | 75 | 80 | 6.25% | 93.75% | 0.16 | 0.25 | 0.41 | −0.3912 |
| 7.5 | 75 | 82.5 | 9.09% | 90.91% | 0.23 | 0.25 | 0.48 | −0.3148 |
| 10 | 50 | 60 | 16.67% | 83.33% | 0.31 | 0.17 | 0.48 | −0.3195 |
| 15 | 10 | 25 | 60.00% | 40.00% | 0.47 | 0.03 | 0.50 | −0.2992 |
| 32 | 0 | 32 | 100.00% | 0.00% | 1.00 | 0.00 | 1.00 | 0.0000 |

The negative values indicate a synergistic response. It is clear from the analysis that relatively low concentrations of lauric arginate and trans-cinnamic acid act synergistically to prevent the outgrowth of various types of spoilage organisms.

### Example 2

A single preparation of base beverage was employed to prepare each of five tests and consisted of 4% apple juice, 68 g sucrose/L, 52 g glucose/L, 2 g fructose/L prepared in batch water that was formulated to 90 ppm hardness with calcium chloride and magnesium chloride. A pH of 3.4 was achieved through combinations of malic acid and sodium malate for all preparations regardless of the presence or absence of lauric arginate or cinnamic acid. The total combined quantity of sodium malate and malic acid was near constant, but the ratio of malic acid and malate varied slightly given the presence or absence of lauric arginate or cinnamic acid. Where required, lauric arginate or cinnamic acid was supplemented from separately prepared stock solutions.

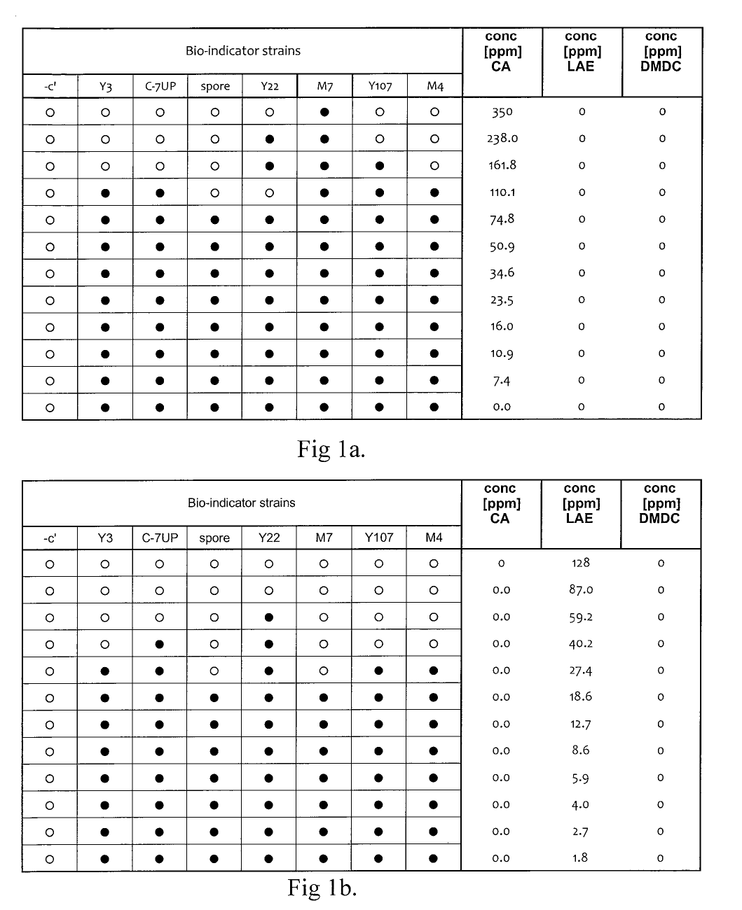

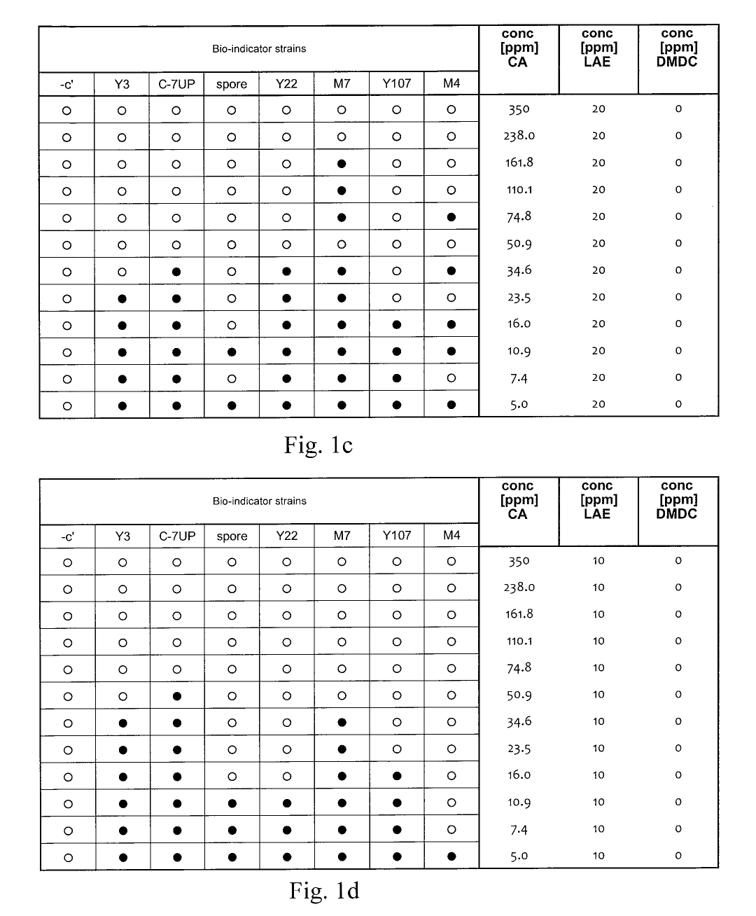

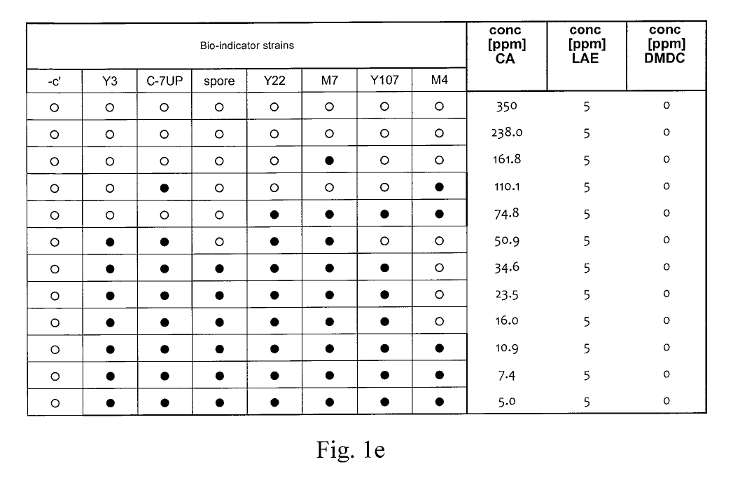

Each of the five tests employed the same bio-indicator organisms; Growth (+) versus no growth (−) established by visual inspection or spectrophotometrically. The organisms and the key (code) employed in FIGS. 1a-1e are as follows: Y3, Zygosaccharomyce baili, Pepsi isolate 906; C-7UP, Brettanomyces species, Pepsi Isolate; Spore, an ascospore preparation of Saccharomyces cerevisiae 99 a Pepsi Isolate; Y22, Zygosaccharomyces baili, ATCC 60484; Spores, M7, Paecilomyces lilacinus ATCC 90461; Y107, Zygosaccharomyces bisporus ATCC 52407; Spores, M4, Talaromvces flavus var. flavus ATCC 10512. Samples were incubated for period of 16 weeks at 25° C. in vessels protective against evaporation. The results are depicted in FIGS. 1a-1e.

The results showed an additive interaction occurs between lauric arginate and cinnamic acid at some but not all mixtures of the two compounds. In addition, it was discovered that cinnamic acid and lauric arginate could be employed in combination as a preservation system at concentrations of each that border on the sensory thresholds for these compounds; 30-35 ppm for cinnamic acid and 10 ppm for lauric arginate.

FIG. 1a shows that concentrations between 161.8 and 238.0 (1.61 mM) cinnamic acid prohibit the outgrowth of all seven bio-indicator strains. The data contained in FIG. 1b indicates that the minimum concentration of lauric arginate required to inhibit the growth of all 7 bio-indicator strains is between 40 and 59 ppm (0.16 mM). The data contained in FIGS. 1c-1e demonstrated that some, but not all, specific combinations of lauric arginate and cinnamic acid function either synergistically or additively with regard to preservative activity. FIG. 1c data provides evidence that all bio-indicator organisms are inhibited by total preservative concentration of 0.16 mM (20 ppm lauric arginate and 16 ppm cinnamic acid). FIG. 1d data indicates that a total preservative concentration of 0.37 mM is sufficient to inhibit the outgrowth of all bio-indicator organisms (51 ppm cinnamic acid combined with 10 ppm lauric arginate). Somewhat surprisingly, a combination of 5 ppm LAE is and 35 ppm cinnamic acid inhibited outgrowth of all bio-indicator organisms (total preservative concentration of 2.38 mM) FIG. 1e.

### Example 3

A single preparation of base beverage was employed to prepare each of five tests and consisted of 4% apple juice, 68 g sucrose/L, 52 g glucose/L, 2 g fructose/L prepared in batch water that was formulated to 90 ppm hardness with calcium chloride and magnesium chloride. A pH of 3.4 was achieved through combinations of malic acid and sodium malate for all preparations regardless of the presence or absence of lauric arginate or cinnamic acid. The total combined quantity of sodium malate and malic acid was near constant, but the ratio of malic acid and malate varied slightly given the presence or absence of lauric arginate or cinnamic acid. It is relevant that the beverage employed for testing does not naturally contain any substance with measurable antimicrobial activity such as essential oils. Where required, lauric arginate or cinnamic acid was supplemented from separately prepared stock solutions. Dimethyl dicarbonate was delivered by means of hypodermic needle (Hamilton syringe) through septum that sealed the test vessel against loss of moisture. Dimethyl dicarbonate stock solution consisted of 1 ml of dimethyl dicarbonate (1.25 g) in 49 ml of 100% ethanol (25 mg/ml). Hence, a microliter of stock contained 25 microgram of dimethyl dicarbonate.

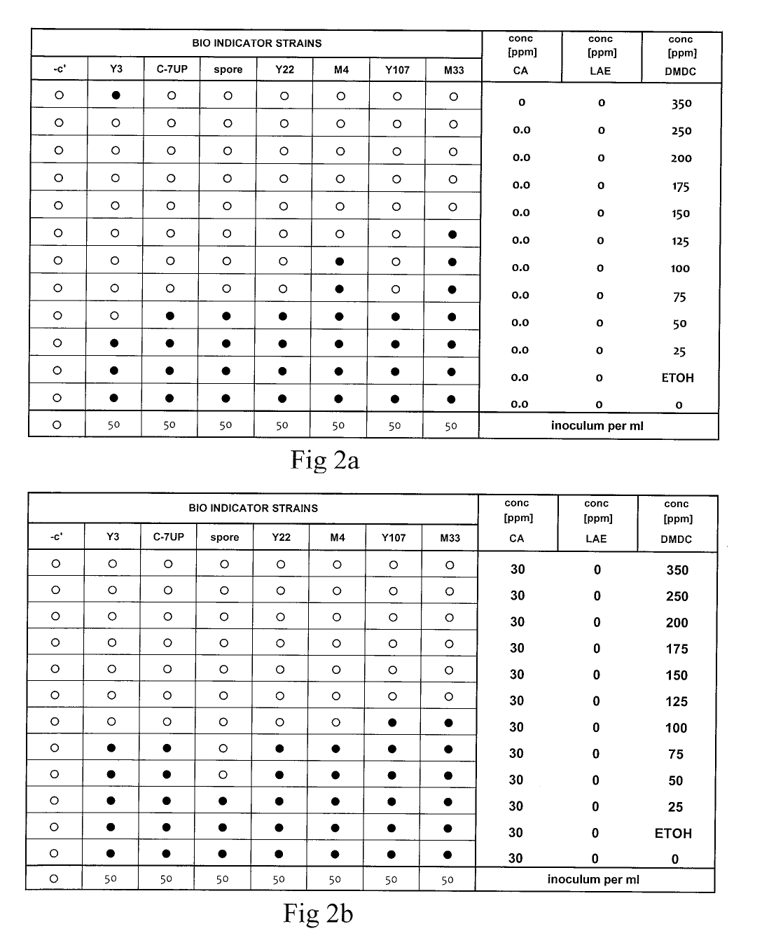

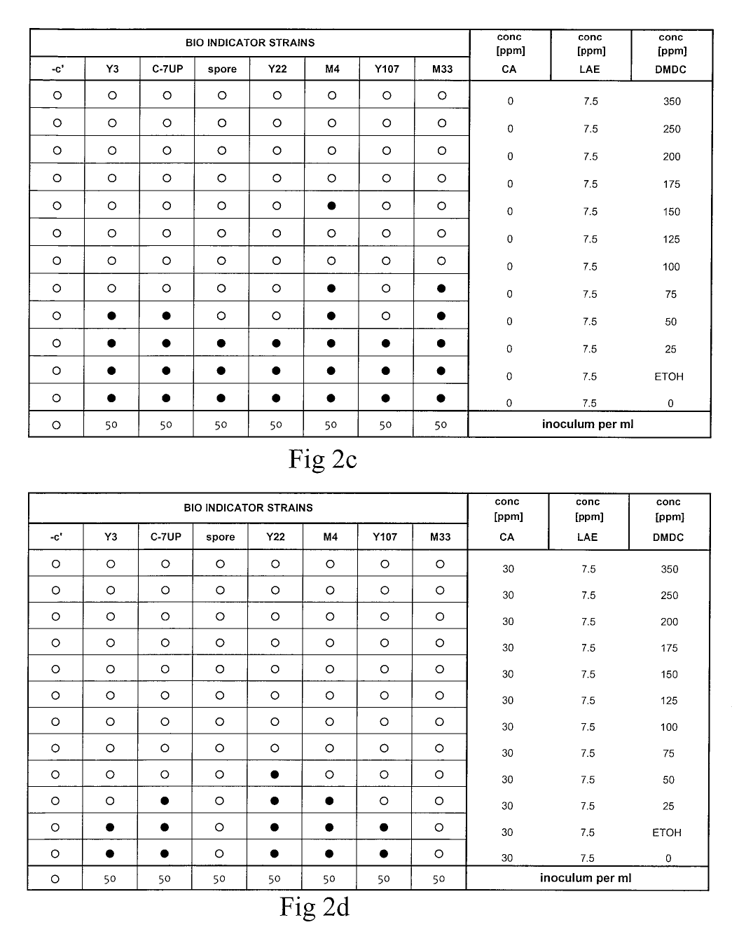

Each of the five tests employed the same bio-indicator organisms; Growth (+) versus no growth (−) established by visual inspection or spectrophotometrically. The organisms and the key (code) employed in FIGS. 2a-2d are as follows: Y3, Zygosaccharomyce baili, Pepsi isolate 906; C-7UP, Brettanomyces species, Pepsi Isolate; Spore, an ascospore preparation of Saccharomyces cerevisiae 99 a Pepsi Isolate; Y22, Zygosaccharomyces baili, ATCC 60484; Spores, M7, Paecilomyces lilacinus ATCC 90461; Y107, Zygosaccharomyces bisporus ATCC 52407; Spores, M4, Talaromyces flavus var. flavus ATCC 10512. Samples were incubated for period of 16 weeks at 25° C. in vessels protective against evaporation. The results are depicted in FIGS. 2a-2d.

The results point to an additive interactions between the three preservative substances.

In the absence of cinnamic acid, 0.95 mM DMDC is required to inhibit the growth of all bio-indicator organisms (FIG. 2a). Only 0.75 mM DMDC is required to accomplish the same when 0.2 mM of Cinnamic acid is also present (FIG. 2b) wherein the combined preservative concentration is 0.95 mM. Lauric arginate (0.02 mM) combines with no greater than 0.75 mM DMDC to accomplish the same degree of inhibition of bio-indicators as found in 0.95 mM DMDC alone (FIG. 2c) suggesting a small degree of synergy (total preservative 0.77 mM). Finally, and most unexpected, 0.2 mM DMDC combines with 0.2 mM Cinnamic acid and 0.02 mM Lauric arginate (combined preservative of 0.48 mM) to prohibit outgrowth of all bio-indicators for the 16 week duration of the test. The combination of Lauric arginate, DMDC and Cinnamic acid appears to act synergistic in this particular instance.

### Example 4

The efficacy of DMDC in a range of existing commercial product types was established in order to establish a baseline for future testing of products in development. A separate test of efficacy of DMDC alone in the test apple juice medium is used in comparison. Simply, four different products that are packaged without preservatives (aseptic package) were purchased from local markets.

The base test beverage formulation (Apple Juice Medium) was prepared as in other tests herewithin, and consisted of 4% apple juice, 68 g sucrose/L, 52 g glucose/L, 2 g fructose/L prepared in batch water that was formulated to 90 ppm hardness with calcium chloride and magnesium chloride. A pH of 3.4 was achieved through combinations of malic acid and sodium malate

Product was transferred to test vessels and vessels were inoculated with bio-indicator organisms. Immediately after inoculation, the test vessels were sealed with septum seal that allowed dosing of DMDC by Hamilton syringe. Dimethyl dicarbonate stock solution consisted of 1 ml of dimethyl dicarbonate (1.25 g) in 49 ml of 100% ethanol (25 mg/ml). Hence, a microliter of stock contained 25 microgram of dimethyl dicarbonate. After dosing with DMDC, the content of each test vessel was immediately mixed by vortex mixing. All testing was performed at ambient and test solutions were at ambient.

Each of the five tests employed the same bio-indicator organisms; Growth (+) versus no growth (−) established by visual inspection or spectrophotometrically. The organisms and the key (code) employed in FIGS. 1a-1e are as follows: Y3, Zygosaccharomyce baili, Pepsi isolate 906; C-7UP, Brettanomyces species, Pepsi Isolate; Spore, an ascospore preparation of Saccharomyces cerevisiae 99 a Pepsi Isolate; Y22, Zygosaccharomyces baili, ATCC 60484; Spores, M7, Paecilomyces lilacinus ATCC 90461; Y107, Zygosaccharomyces bisporus ATCC 52407; Spores, M4, Talaromyces flavus var. flavus ATCC 10512. Samples were incubated for period of 16 weeks at 25 ° C. in vessels protective against evaporation. The results are depicted in FIGS. 1a-1e.

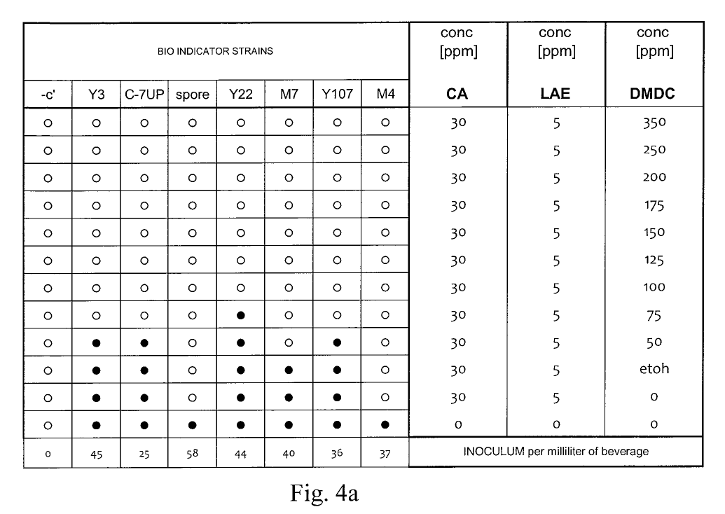

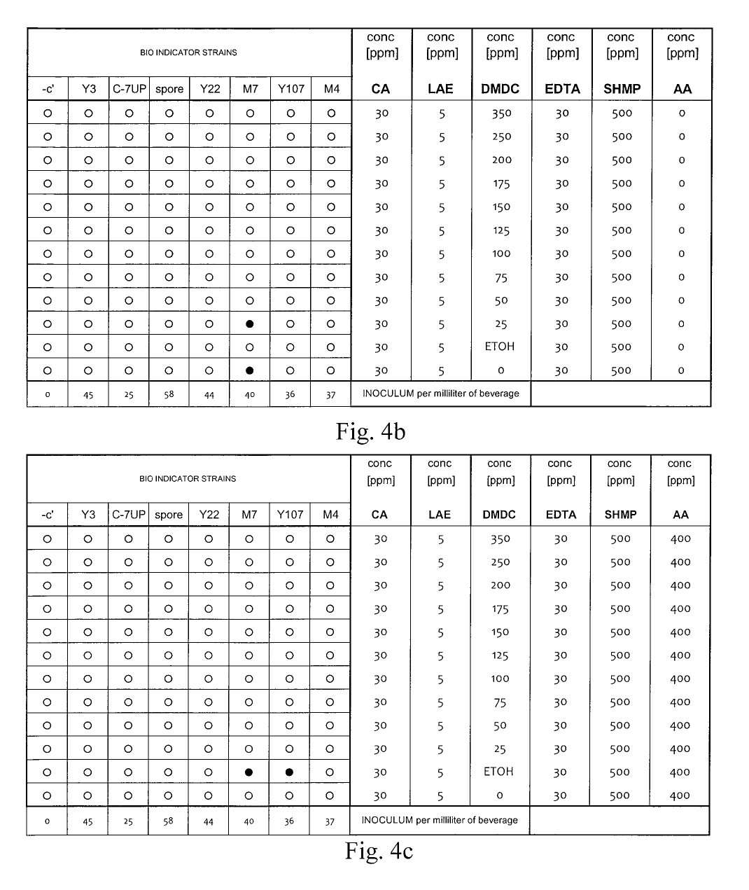

FIG. 4a provides an estimate of the amount of DMDC that is required to preserve a sports beverage containing a cloud emulsion (pH 3.2). Many of the bio-indicator organisms were unable to initiate growth even in the absence of DMDC and this is likely a reflection of the high concentration of salt and the low concentration of reduced nitrogen. However, the mold species were quite adapt at growth and the minimum concentration of DMDC that was required to preserve this formulation is greater than 200 ppm (1.49 mM). Such a result is consistent with the claims of suppliers of DMDC.

Interestingly, a commercial beverage composed principally of tea (pH 3.3) with a supplement of honey was found to be unstable against spoilage at least one bio-indicators when DMDC was added to final concentration of 2.61 mM (350 ppm) (FIG. 4b). This is measurably in excess of the regulatory limits (250 ppm) currently in place for the most countries including the U.S. and E.U. nations.

A juice (tangerine) containing beverage (pH 3.4) with a measurable juice cloud to which only DMDC was added was stable against spoilage when the dose of DMDC was on the order of 150 ppm (1.12 mM) as shown in FIG. 4c. A green tea formulation containing lemon flavor was stabilized with DMDC concentration of 0.75 mM (FIG. 4d). FIG. 4e demonstrates the need for at least 275 ppm (2.05 mM) DMDC in order to preserve the base test medium (4% apple juice).

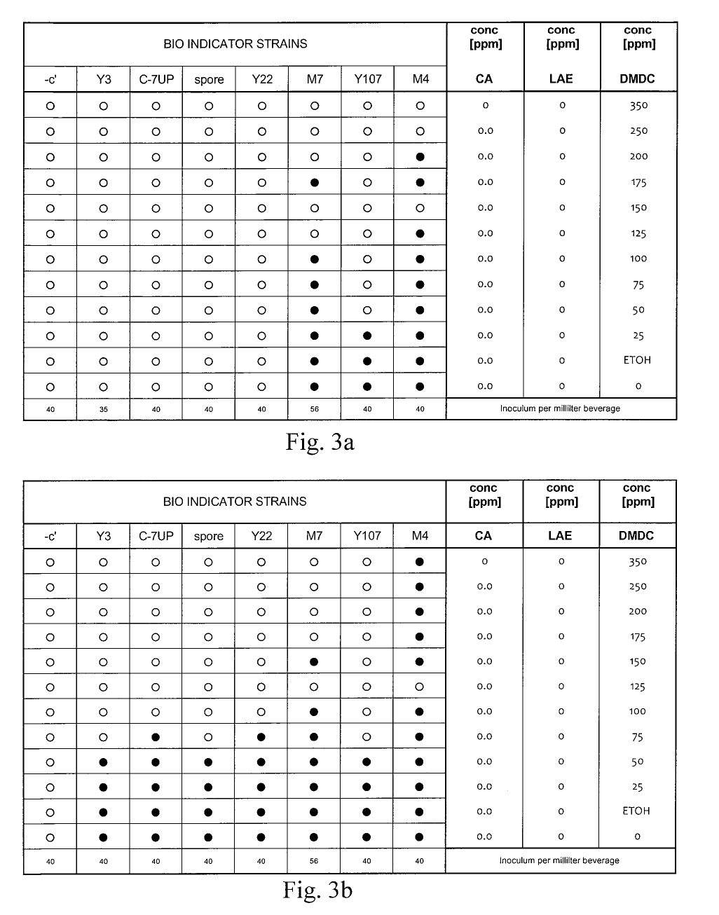

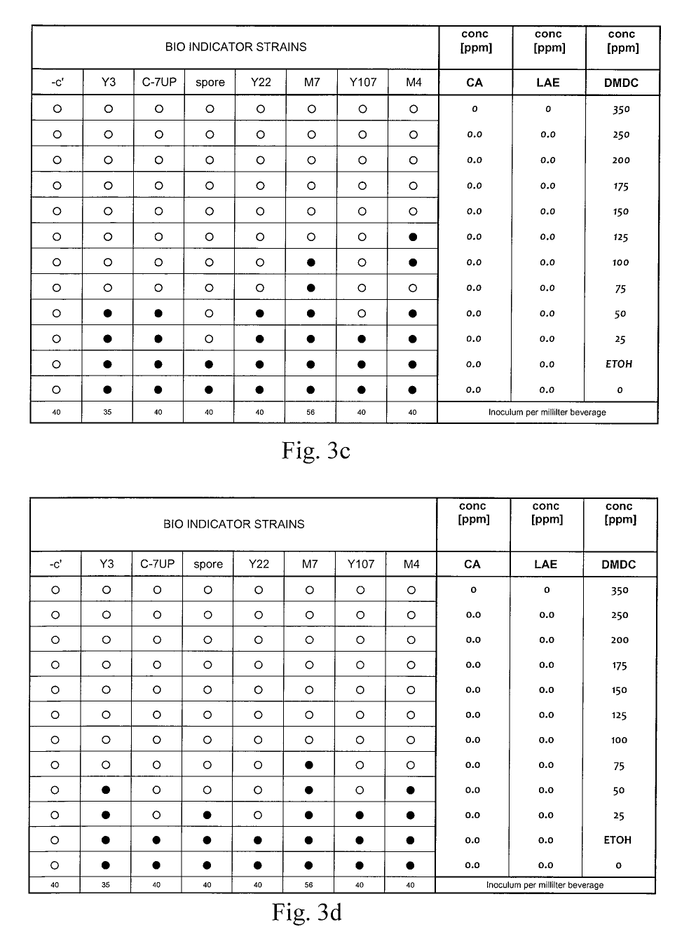

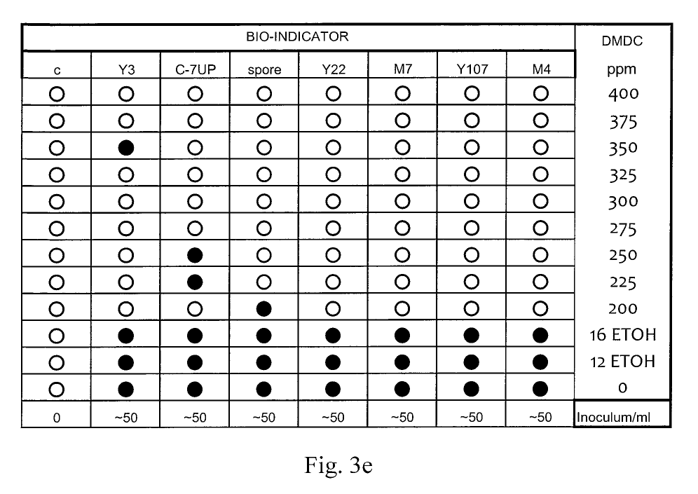

Collectively, the data from FIGS. 3a through 3d indicate that different beverage formulations challenged with the same bio-indicator organisms will demonstrate different requirements for dosing with DMDC if only DMDC is employed to preserve the product. Given the nature of the underlying reaction that allows DMDC to function as a preservative (methoxcarbonylation of imidazole groups) it is not measurably surprising that differing amounts of DMDC would be employed in the preservation of a beverage of differing amino acid or protein content.

It should be apparent from the samples provided in FIG. 3a-3e that many still beverages cannot be made stable through the use Dimethyl dicarbonate alone if restricted to a typical legal dose (typically 250 ppm). Further, it should be clear that different types of beverage will require differing dose requirements of DMDC if it is the only preservative employed. For many reasons, the adjustment to the dose of DMDC (during a change-over from one product to another) is problematic for most, if not all, production facilities. Among other issues, the changes required might prove both difficult and dangerous; in that a chemical spill or leak of DMDC can prove lethal. Safety issues aside, the use of DMDC as a stand alone preservative is expensive. Ideally, a combination of preservative activity is preferred wherein DMDC is part of the preservative mixture and wherein a relatively small and constant dose can be applied to any number of beverage formulations.

### Example 5

A single preparation of base beverage was employed to prepare each of three tests and consisted of 4% apple juice, 68 g sucrose/L, 52 g glucose/L, 2 g fructose/L prepared in batch water that was formulated to 90 ppm hardness with calcium chloride and magnesium chloride. A pH of 3.4 was achieved through combinations of malic acid and sodium malate for all preparations regardless of the presence or absence of lauric arginate or cinnamic acid. The total combined quantity of sodium malate and malic acid was near constant, but the ratio of malic acid and malate varied slightly given the presence or absence of lauric arginate or cinnamic acid. Where required, lauric arginate or cinnamic acid was supplemented from separately prepared stock solutions. Dimethyl dicarbonate was delivered by means of hypodermic needle (Hamilton syringe) through septum that sealed the test vessel against loss of moisture. Dimethyl dicarbonate stock solution consisted of lml of dimethyl dicarbonate (1.25 g) in 49 ml of 100% ethanol (25 mg/ml). Hence, a microliter of stock contained 25 microgram of dimethyl dicarbonate. Samples were dosed with DMDC immediately after inoculation and each sample was mixed thoroughly by vortex mixer. All solutions were ambient at the time of dose application.

The addition of ascorbic acid, EDTA or SHMP was accomplished through transfer from stock solutions of these substances. The volumes required were purposely small. Adjustments were made for each type of medium if a measurable difference in volume was required. In no instance did the concentration of a preservative substance differ across tests.

Each of the three tests employed the same bio-indicator organisms; Growth (+) versus no growth (−) established by visual inspection or spectrophotometrically. The organisms and the key (code) employed in FIGS. 4a-4c are as follows: Y3, Zygosaccharomyce baili, Pepsi isolate 906; C-7UP, Brettanomyces species, Pepsi Isolate; Spore, an ascospore preparation of Saccharomyces cerevisiae 99 a Pepsi Isolate; Y22, Zygosaccharomyces baili, ATCC 60484; Spores, M7, Paecilomyces lilacinus ATCC 90461; Y107, Zygosaccharomyces bisporus ATCC 52407; Spores, M4, Talaromyces flavus var. flavus ATCC 10512. Samples were incubated for period of 16 weeks at 25° C. in vessels protective against evaporation. The results are depicted in FIGS. 4a-4c.

In the instance of the addition of dimethyl dicarbonate, lauric arginate and cinnamic acid (FIG. 4a) a rather surprising and unexpected result occurred. A combination of 0.9 6 mM preservative in the form 0.014 mM lauric arginate, 0.2 mM cinnamic acid and 0.74 mM dimethyl dicarbonate sufficed to inhibit the outgrowth of all bio-indicator strains. The additive effect of the three compounds allows for the use of concentrations of both cinnamic acid and lauric arginate well below the concentration of sensory threshold. Additionally, the low concentration of lauric arginate employed in this mixture allows the use of this preservative mixture in beverages that contain phenolics that would tend to precipitate in the presence lauric arginate at concentrations much above 5-10 ppm.

FIG. 4b offers a result that is very favorable with regard to the use DMDC, lauric arginate and cinnamic acid in conjunction with sequestrants. When sodium hexametaphosphate (500 ppm) and EDTA (30 ppm) are present in the beverage, the combined concentration of LAE, DMDC and cinnamic acid required to inhibit growth is no more than 0.58 mM. Unexpectedly, the amount of DMDC required is no more than 100 ppm and appears to be as low as 50 ppm. This result is favorable toward development of a process wherein a single dose of DMDC can be employed for a range of products. The addition of ascorbic acid to 400 ppm to the beverage formulation may allow for even lower concentrations of DMDC. In FIG. 4c, the total amount of preservative required to preserve product to 0.4 mM and only 25 ppm DMDC need be applied to the beverage.

### Example 6

A single preparation of base beverage was employed to prepare each of five tests. The beverage formulation chosen mimics that of an enhanced water product and is composed per liter as follows 37.2 mg Acesulfame K+; 100mg Vitamin E acetate, 54.1 mg Vitamin B mix, 331 mg sucralose 748 mg grape flavor, 3236 mg of liquid sucrose, 26.5 mg antifoam, 20 mg polysorbate. The ingredients were added to RO water adjusted to 90 ppm hardness with calcium chloride and magnesium chloride. The acidity of the product was adjusted to pH 4.5 with a mixture of succinic acid and Sodium succinate dibasic hexadydrate. The total concentration of succinic acid in solution was approximately 8 mM.

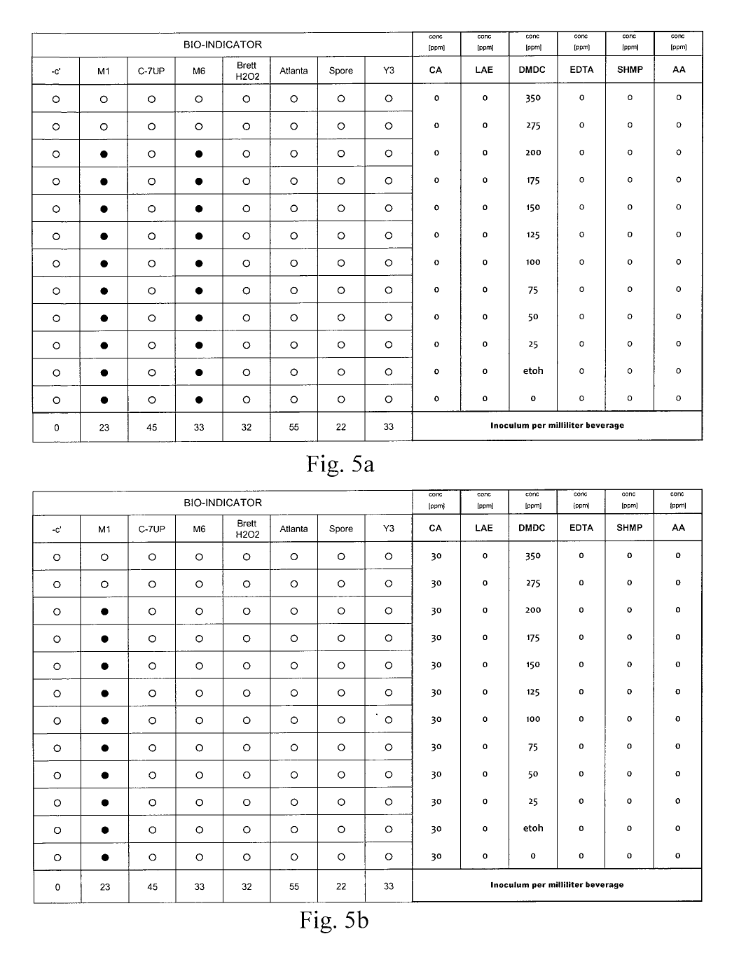

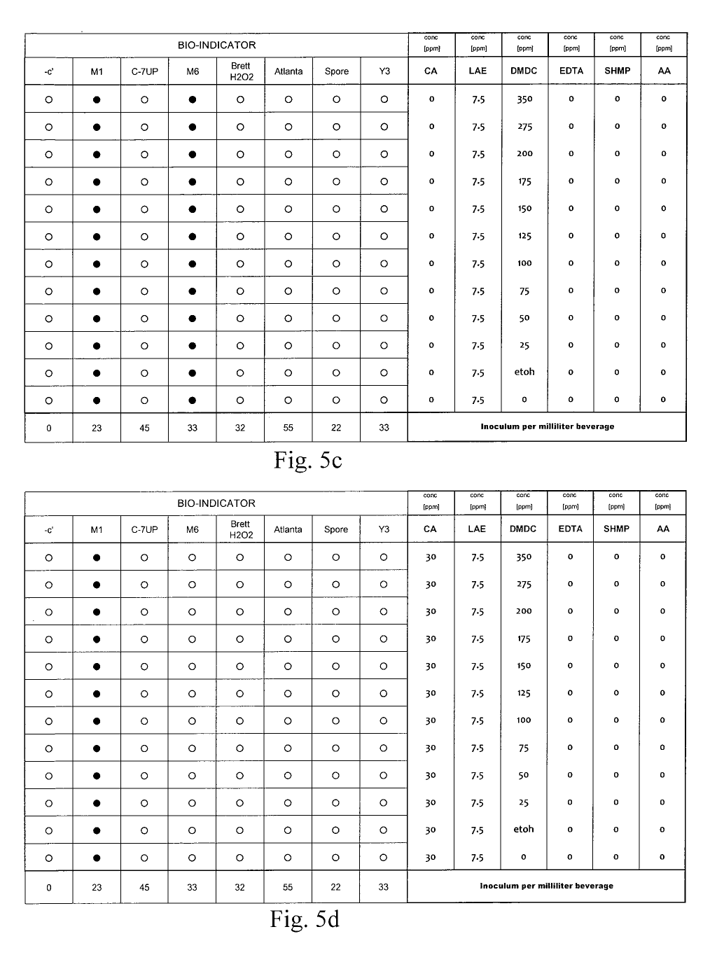

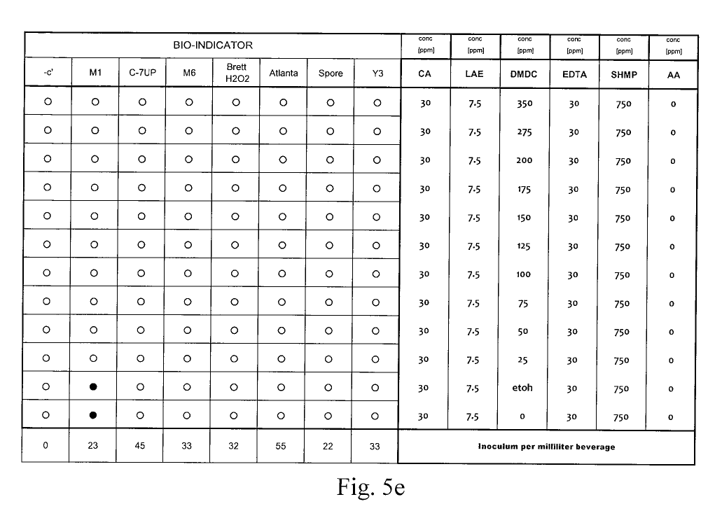

Each of the five tests employed the same bio-indicator organisms; Growth (+) versus no growth (−) established by visual inspection or spectrophotometrically. The organisms and the key (code) employed in FIGS. 5a-5e are as follows: Spores, M1 Paecilomyces/Byssochalmys nieva, Pespi isolate D16; C-7UP, Brettanomyces species, Pepsi Isolate; Spores, M6, Talaromyces flavus var. flavus ATCC 10512; Brettanomyces species, Pepsi isolate H202; Acetobacter species, Pepsi isolate “Atlanta”; an ascospore preparation of Saccharomyces cerevisiae strain 99(Spore) and Y3, Zygosaccharomyce baili, Pepsi isolate 906;. Samples were incubated for period of 16 weeks at 25° C. in vessels protective against evaporation. The results are depicted in FIGS. 5a-5e.

As can be readily established in a review of the FIGS. 5a-5e, many of the bio-indicator strains were not inclined to grow in this particular beverage formulation, despite a very favorable pH (4.5). However, the results for the two mold strains (M1 and M6) are sufficiently satisfactory and, again, draw attention to favorable and very unexpected interactions between DMDC, cinnamic acid, and lauric arginate. FIG. 5a clearly demonstrates the tolerance of M1 and M6 to concentrations of DMDC at least as high as 200 ppm wherein DMDC is the singular antimicrobial agent present in the beverage. The addition of 30 ppm cinnamic acid (FIG. 5b) to the formulation prior to the addition of DMDC eliminates the risk of spoilage from M6 but presence of cinnamic acid has no effect on M1. Hence, the combination of DMDC and cinnamic acid provides only a relatively small reduction to the overall risk of spoilage. Clearly, neither M1 or M6 proved sensitive to the presence of 7.5 ppm lauric arginate over a range of DMDC concentrations (FIG. 5c) and the combination of lauric arginate (7.5 ppm) cinnamic acid (30 ppm) in the presence of various doses of DMDC was no more effective than the combination of cinnamic acid and DMDC (FIG. 5b). Given the results of 5a-5d, the results shown in FIG. 5e are particularly unexpected. Here, a formulation of pH 4.5 containing 30 ppm cinnamic acid, 7.5 ppm lauric arginate (both below concentration of sensory detection) and permissible concentrations of EDTA and SHMP is found to be refractive to spoilage by mold when dosed with 25 ppm DMDC. It should be noted that cinnamic acid has a particularly high plc, value (4.42) and at least 45% of the cinnamic acid added to beverage is in the form of the un-dissociated acid.

### Example 7

A single preparation of base beverage was employed to prepare each of five tests. The beverage formulation chosen mimics that of a green tea beverage composed per liter as follows: 170 mg Citrus Pectin; 500 mg honey granules 550 mg Acerola Dry Vitamin C, 1,332 mg green tea solid, 2,046 mg tea flavor; 65,590 mg granulated sucrose. The ingredients were added to RO water adjusted to 90 ppm hardness with calcium chloride and magnesium chloride. The acidity of the product was adjusted to pH 5.5 with a mixture of succinic acid and sodium succinate dibasic hexadydrate. The total concentration of succinic acid in solution was approximately 8 mM.

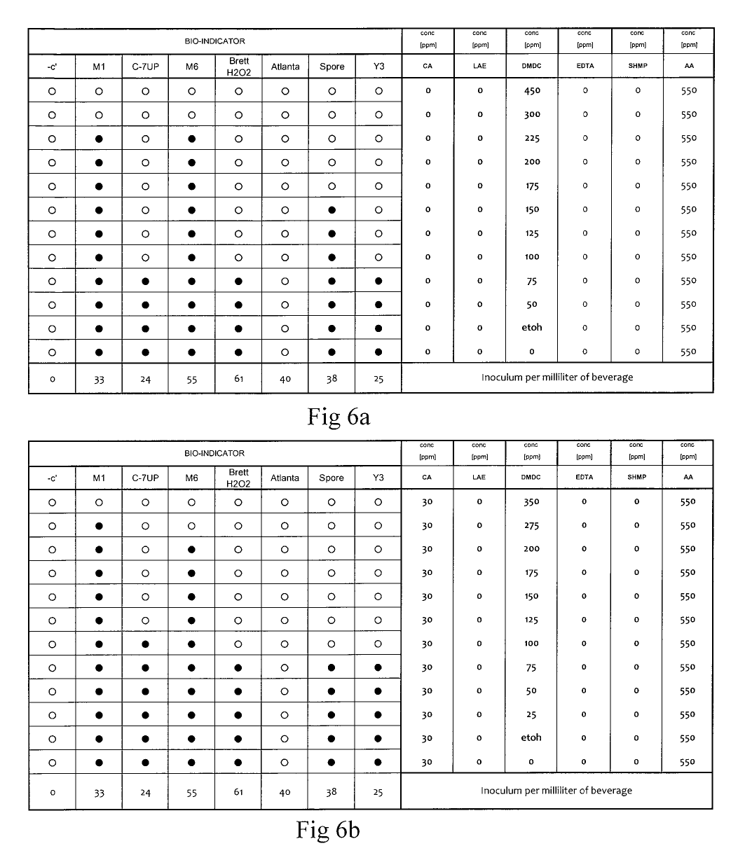

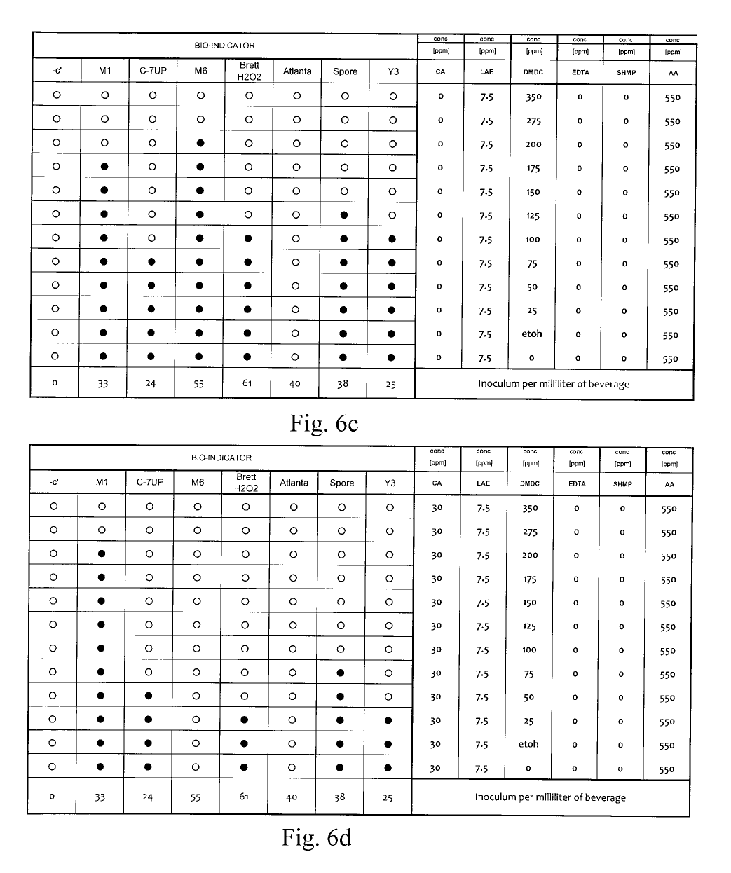

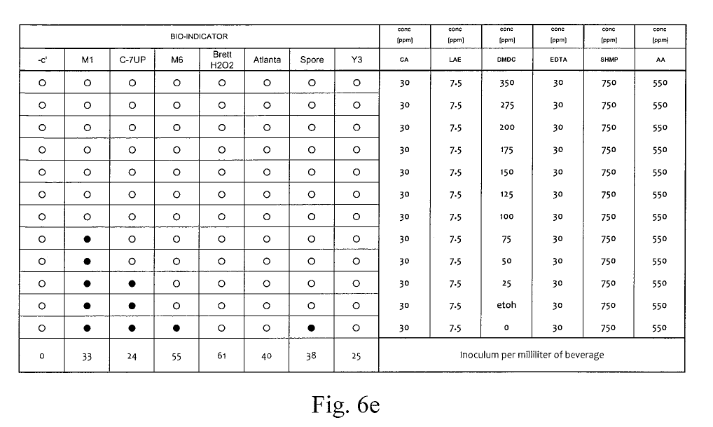

Each of the five tests employed the same bio-indicator organisms; Growth (+) versus no growth (−) established by visual inspection or spectrophotometrically. The organisms and the key (code) employed in FIGS. 6a-6e are as follows: Spores, M1 Paecilomyces/Byssochalmys nieva, Pespi isolate D16; C-7UP, Brettanomyces species, Pepsi Isolate; Spores, M6, Talaromyces flavus var. flavus ATCC 10512; Brettanomyces species, Pepsi isolate H202; Acetobacter species, Pepsi isolate “Atlanta”; an ascospore preparation of Saccharomyces cerevisiae strain 99(Spore) and Y3, Zygosaccharomyce baili, Pepsi isolate 906;. Samples were incubated for period of 16 weeks at 25° C. in vessels protective against evaporation. The results are depicted in FIGS. 6a-6e.

As can be readily established in a review of the FIGS. 6a-6e, most of the bio-indicator strains were able to initiate growth in this formulation when preservatives and sequestrants were absent. Otherwise, the results closely mimic the results from FIG. 5. As in the instance of FIG. 5, the mold strains M1 and M6 proved quite tolerant to a dose of DMDC in the absence of other preservatives. The minimum inhibitory concentration of DMDC required to preserve the pH 5.5 tea beverage is in excess of 225 ppm DMDC. All fungi bio-indicators demonstrated at least some tolerance to DMDC in the absence of cinnamic acid and lauric arginate (FIG. 6a).

Although the addition of 30 ppm cinnamic acid to the formulation prior to the addition of DMDC eliminates the risk of spoilage in enhance water beverage (FIG. 5b) such is not the case in the tea beverage (FIG. 6b) Both M1 and M6 appear equally immune to the presence of 30 ppm cinnamic acid in the presence of DMDC. Irrespective of the presence of cinnamic acid, the same concentration of DMDC is required for inhibition of mold growth. In fact, the majority of fungi demonstrated the same degree of tolerance to DMDC in the presence and absence of 30 ppm cinnamic acid.

Clearly, neither M1 or M6 demonstrated enhanced sensitivity to DMDC in the presence of 7.5 ppm lauric arginate over a range of DMDC concentrations tested (FIG. 6c). The result parallels the finding in FIG. 5c. Neither did the presence of 7.5 ppm lauric arginate enhance the sensitivity of yeast fungi to the presence of DMDC in this particular instance.

The lauric arginate (7.5 ppm) and cinnamic acid (30 ppm) combined and in the presence of various doses of DMDC was measurably more effective than the combination of either cinnamic acid or lauric arginate with DMDC (FIG. 6d). Except for strain M1, all fungi proved more susceptible to DMDC in the beverage containing both lauric acid and cinnamic acid completely, than in beverage that separately contained either lauric acid or cinnamic acid. However, because of the result with MI, there is no clear advantage (in this particular instance) of the lauric arginate-cinnamic acid mixture over a formulation containing either cinnamic acid or lauric arginate. It should be noted that although cinnamic acid has a particularly high pKₐ value (4.42), no more than least 7.6% of the cinnamic acid added to beverage is in the form of the un-dissociated acid at pH 5.5.

Despite a pH 5.5, a tea beverage appears to be preserved by the combination of cinnamic acid, lauric arginate and the combination of the sequestrants EDTA and SHMP if DMDC is dosed at a concentration of no more than 100 ppm. In many respects this result parallels the finding for the enhance water beverage (FIG. 6e). The contribution by ascorbic acid is not quantifiable in this particular test, but it appears that ascorbic acid can play a supportive role in the preservation of a product.

### Example 8

A single preparation of base beverage was employed to prepare each of five tests. The beverage formulation chosen mimics that of a Energy beverage and is composed per liter as follows: 209 mg Rebaudioside A (REB A), 248 mg Potassium Citrate 248 mg Flavor-vitamin mixture, 248 mg calcium lactate, 298 mg Xanthan gum, 668 mg citric acid 995 mg color, 995 mg Pomegranate flavor, 24900 mg erythritol. The ingredients were added to RO water adjusted to 90 ppm hardness with calcium chloride and magnesium chloride. The acidity of the product was adjusted to pH 2.85 with a mixture of citric acid and sodium citrate. The total concentration of citric acid in solution did not appreciably change from that provide in above formulation.

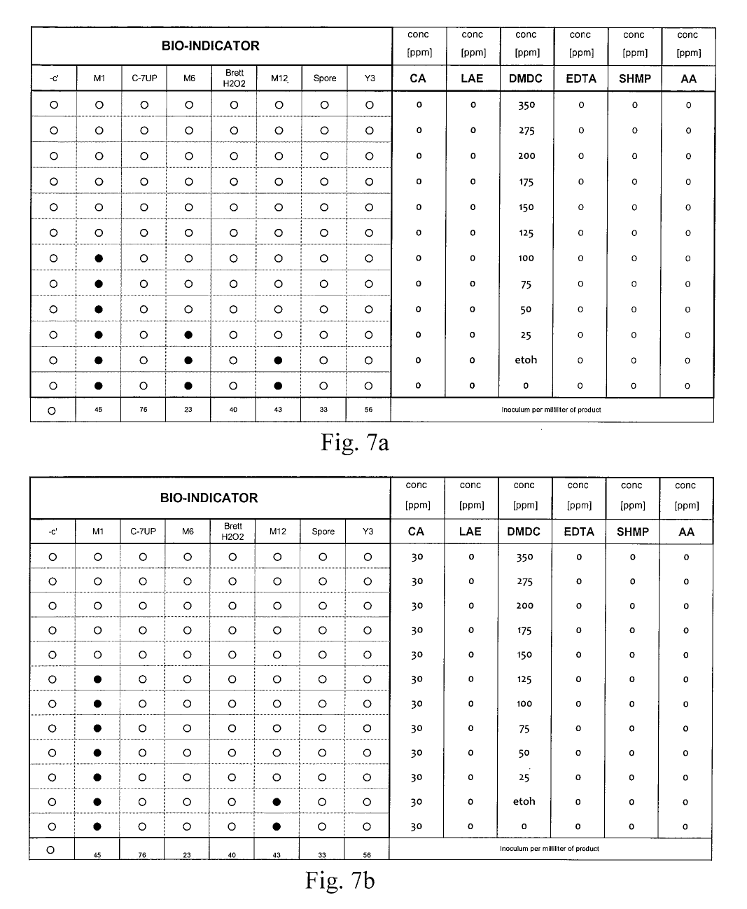

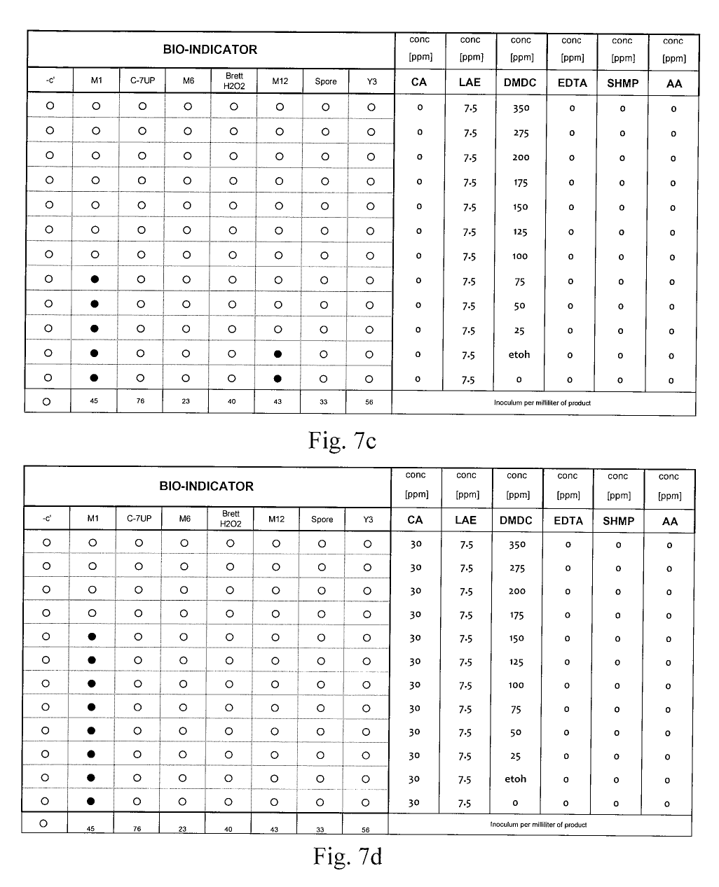

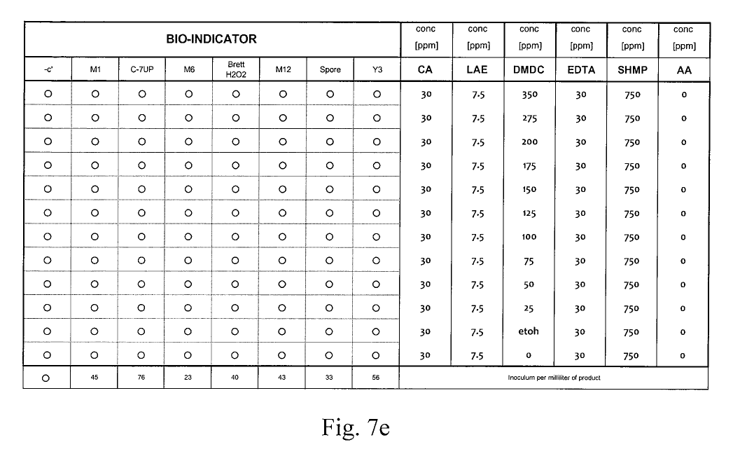

Each of the five tests employed the same bio-indicator organisms; Growth (+) versus no growth (−) established by visual inspection or spectrophotometrically. The organisms and the key (code) employed in FIGS. 7a-7e are as follows: Spores, M1 Paecilomyces/Byssochalmys nieva, Pespi isolate D16; C-8UP, Brettanomyces species, Pepsi Isolate; M6, Talaromyces flavus var. flavus ATCC 10512; Brettanomyces species, Pepsi isolate H2O2; Spores, M12 Penicillium camebertii (Pepsi isolate D1)”; an ascospore preparation of Saccharomyces cerevisiae strain 99(Spore) and Y3, Zygosaccharomyce baili Pepsi isolate 906;. Samples were incubated for period of 16 weeks at 25° C. in vessels protective against evaporation. The results are depicted in FIGS. 7a-7e.

As can be readily established in a review of the FIGS. 7a-7e, only mold fungi bio-indicator strains were able to initiate growth in this formulation when preservatives and sequestrants were absent. Hence, these organisms are those for which the largest concern would exist.

The results closely mimic the results from FIGS. 5 and 6. As in the instance of FIGS. 5 and 6, the mold strains proved quite tolerant to a dose of DMDC in the absence of other preservatives. At the same time, a comparison of results between FIGS. 5 and 6 versus 7 is supportive of the possibility of a pH effect for DMDC. The pH of the beverage in FIG. 7 is much lower than in FIG. 5 or 6 and it appears that M1 is more sensitive to DMDC at the lower pH. The minimum inhibitory concentration of DMDC required to preserve the pH 2.9 energy beverage is less than 125 ppm DMDC. All fungi bio-indicators demonstrated at least some tolerance to DMDC in the absence of cinnamic acid and lauric arginate (FIG. 7a).

The addition of 30 ppm cinnamic acid to the formulation prior to the addition of DMDC further reduces the risk of spoilage in enhance water beverage (FIG. 7b). One of three mold types is eliminated form the pool of potential spoilage organisms simply with the addition of 30 ppm cinnamic acid. When cinnamic acid is present in beverage at 30 ppm, a second mold is eliminated as a spoilage organism when DMDC is dosed at a concentration of only 25 ppm. 30 ppm cinnamic acid and a dose of 150 ppm DMDC prevent the growth of all spoilage organisms.

Nearly as effective as the mixture of cinnamic acid and DMDC is the mixture of lauric arginate and DMDC (FIG. 7c). A relatively low concentration of lauric arginate (7.5 ppm) allows the use the relatively small dose of 125 ppm DMDC in order to ensure all bio-indicators are inhibited from growth. Only one of three mold species is tolerant to mixtures of DMDC, LAE and cinnamic acid in this beverage formulated at pH 2.85 (FIG. 7d). The lauric arginate (8.5 ppm) and cinnamic acid (30 ppm) combined and in the presence of various doses of DMDC was measurably more effective than the combination of either cinnamic acid or lauric arginate with DMDC (FIG. 7d). Except for strain M1, all fungi proved more susceptible to DMDC in the beverage containing both LAE and cinnamic acid.

Product that is dosed with DMDC and that contains a combination of cinnamic acid, lauric arginate in addition to sequestrants EDTA and SHMP again provided the best overall best method to preserve a formulation. Clearly, some organisms are sensitive to the combination of sequestrant, cinnamic acid and lauric arginate in the absence of DMDC. However, in each of three different tests (FIGS. 5, 6, and 7) the same mold (M1) proves tolerant to the mixtures in the absence of a DMDC dose. The best preservation system in all beverage formulations tested is one that includes DMDC dosing in combination with lauric arginate, cinnamic acid and the sequestrants EDTA and SHMP.

Various examples of the present invention have been described above, and it will be understood by those of ordinary skill that the present invention includes within its scope all combinations and subcombinations of these examples. Additionally, those skilled in the art will recognize that the above examples simply exemplify the invention. Various changes and modifications may be made without departing from the spirit and scope of the invention, as defined in the appended claims.

What is claimed is:

1. A beverage preservative system comprising:
an additive or synergistic combination of at least two preservatives selected from the group consisting of trans-cinnamic acid or suitable salt thereof, dimethyl dicarbonate, and lauric arginate; and
wherein the beverage preservative system prevents spoilage by microorganisms in a beverage within a sealed container for a period of at least 16 weeks.

2. The beverage preservative system of claim 1 comprising a combination of trans-cinnamic acid or suitable salt thereof and dimethyl dicarbonate.

3. The beverage preservative system of claim 1 comprising a combination of trans-cinnamic acid or suitable salt thereof and lauric arginate.

4. The beverage preservative system of claim 1 comprising a combination of dimethyl dicarbonate and lauric arginate.

5. A beverage comprising:
a beverage component and an additive or synergistic combination of at least two preservatives selected from the group consisting of trans-cinnamic acid or suitable salt thereof, dimethyl dicarbonate, and lauric arginate;
wherein the beverage has a pH of 2.5 to 7.5; and the beverage preservative system prevents spoilage by microorganisms in a beverage within a sealed container for a period of at least 16 weeks.

6. The beverage of claim 5 having a pH in the range of 2.5 to 4.6.

7. The beverage of claim 5 comprising a combination of lauric arginate and dimethyl dicarbonate, wherein the lauric arginate is present at a concentration in the range of about 0.1 ppm to about 25 ppm and the dimethyl dicarbonate is present at a concentration in the range of about 25 ppm to about 250 ppm.

8. The beverage of claim 7 wherein the lauric arginate is present at a concentration of about 2 ppm to about 10 ppm.

9. The beverage of claim 7 wherein the dimethyl dicarbonate is present at a concentration of about 50 ppm to about 200 ppm.

10. The beverage of claim 5 comprising a combination of trans-cinnamic acid and dimethyl dicarbonate, wherein the trans-cinnamic acid or suitable salt thereof is present at a concentration in the range of about 0.1 ppm to about 50 ppm and the dimethyl dicarbonate is present at a concentration in the range of about 25 ppm to about 250 ppm.

11. The beverage of claim 10 wherein the trans-cinnamic acid or suitable salt thereof is present at a concentration of about 1 ppm to about 40 ppm.

12. The beverage of claim 10 wherein the dimethyl dicarbonate is present at a concentration of about 50 ppm to about 200 ppm.

13. The beverage of claim 5 comprising a combination of trans-cinnamic acid or suitable salt thereof and lauric arginate, wherein the trans-cinnamic acid or suitable salt thereof is present at a concentration in the range of about 0.1 ppm to about 50 ppm and the lauric arginate is present at a concentration in the range of about 0.1 ppm to about 25 ppm.

14. The beverage of claim 13 wherein the trans-cinnamic acid or suitable salt thereof is present at a concentration of about 1 ppm to about 40 ppm.

15. The beverage of claim 13 wherein the lauric arginate is present at a concentration of about 2 ppm to about 10 ppm.

16. The beverage of claim 5 comprising lauric arginate, trans-cinnamic acid or suitable salt thereof, and dimethyl dicarbonate.

17. The beverage of claim 16 wherein lauric arginate is present at a concentration in the range of about 0.1 ppm to about 25 ppm, trans-cinnamic acid or suitable salt thereof is present at a concentration in the range of about 0.1 ppm to about 50 ppm, and dimethyl dicarbonate is present at a concentration in the range of about 25 ppm to about 250 ppm.

18. The beverage of claim 5 wherein the beverage component comprises at least one of added water, a juice, a flavorant, a sweetener, an acidulant, a colorant, a vitamin, a buffering agent, a thickener, an emulsifier, and an anti-foaming agent.

19. The beverage of claim 18 wherein the beverage component comprises fruit juice from at least one of orange, grapefruit, lemon, lime, tangerine, apple, grape, cranberry, raspberry, blueberry, strawberry, pineapple, pear, peach, pomegranate, prune, cherry, mango, papaya, lychee, and guava.

20. The beverage of claim 5 wherein the beverage is a carbonated beverage, a non-carbonated beverage, a soft drink, a fruit juice, a fruit juice flavored drink, a fruit-flavored drink, an energy drink, a hydration drink, a sport drink, a health and wellness drink, a fountain beverage, a frozen ready-to-drink beverage, a frozen carbonated beverage, a liquid concentrate, a coffee beverage, a tea beverage, a dairy beverage, a soy beverage, a vegetable drink, a flavored water, an enhanced water, or an alcoholic beverage.

21. The beverage of claim 5 wherein metal cations of chromium, aluminum, nickel, zinc, copper, manganese, cobalt, calcium, magnesium, and iron are present at a total concentration in the range of 0.5 mM to 0.75 mM.

22. The beverage of claim 5 further comprising a sequestrant.

23. The beverage of claim 28 wherein the sequestrant is EDTA or EDDS or mixtures thereof

24. The beverage of claim 5 further comprising at least one polyphosphate or diphosphonic acid.

25. The beverage of claim 5 wherein the beverage has been heated to above 71° C., cooled to no greater than 76° C., and filled into a container such that no part of container exceeds about 71° C.
